(19) United States
(12) Patent Application Publication
(10) Pub. No.: US 2003/0033381 A1
(43) Pub. Date: Feb. 13, 2003

(54) Data communication apparatus providing advertisement information and data communication computer calculating advertisement fee

(76) Inventor: Toru Hanaoka, Osaka (JP)

Correspondence Address: BIRCH STEWART KOLASCH & BIRCH, PO BOX 747, FALLS CHURCH, VA, 22040-0747, US

(21) Appl. No.: 10/207,274

(22) Filed: Jul. 30, 2002

(30) Foreign Application Priority Data
Aug. 1, 2001 (JP) 2001-233214 (P)

(51) Int. Cl. G06F 15/16

(52) U.S. Cl. 709/218; 709/203

(57) ABSTRACT

A communication system includes a CMTS provided at a CATV station, an advertisement server computer, and a modem provided at a user's residence. The modem includes a circuit receiving data transmitted from the Internet and advertisement information transmitted from the advertisement server computer, a circuit converting the received data into data for transmission to a personal computer, and a circuit displaying the received advertisement information. The advertisement server computer includes a circuit calculating an advertisement fee to be collected from an advertiser as a value of having a user of the modem viewing advertisement information, and a circuit calculating a reduced communication fee by appropriating the advertisement fee for the communication fee to be paid by the user to the CATV service provider.

### BACKGROUND OF THE INVENTION

1. Field of the Invention

The present invention relates to a network connecting computers, and more particularly to the approach of alleviating the amount of fee required for network connection at the user side in a continuous-connection network.

2. Description of the Background Art

In accordance with the broad usage of the Internet and the increase of the size of downloaded data, a communication system that allows high-speed communication is adapted to practical use. One such system is the communication system employing a CATV (Cable Television) line.

In this system, a CMTS (Cable Modem Terminal Station) provided at the CATV station is connected to a cable modem provided at the home of a user through a CATV line, whereas a cable modem is connected with a user's personal computer through a LAN (Local Area Network) line. The CMTS is connected to the Internet. In a frequency bandwidth of the CATV line used for the transmission of television video data, data is transmitted at high speed between the network of the Internet and a personal computer through a channel that is not used.

Japanese Patent Laying-Open No. 10-66051 discloses a system employing such a CATV line. This system is a computer on-line system using a CATV line. This system includes a first communication modem provided at a head end device, a second communication modem having a predetermined address, connected to a computer device through a LAN line, and a CATV line establishing connection between the first communication modem and the second communication modem. The first communication modem includes a detection circuit measuring the line error rate and traffic amount, an accounting memory circuit accumulating the accounting information of a subscriber, and a transmission circuit transmitting the information to the second communication modem when the line is available. The second communication modem includes a memory circuit to store the data received from the first communication modem, a circuit to retrieve line information or accounting information, when included in the received data, and provide the same to the memory circuit, and a display circuit reading out and displaying the line error rate, traffic amount, and accounting information stored in the memory circuit.

According to the system disclosed in this publication, line information including the error rate of line and traffic amount of the line as well as the accounting information of a subscriber are detected by the first communication modem, and downloaded to the second communication modem when the line is available. Since the second communication modem has the line information and accounting information stored in the memory circuit to be displayed at the display circuit, the subscriber can confirm the error rate and traffic amount of the line to readily diagnose the line. The subscriber can confirm information such as the line usage fee and the like free of charge. Therefore, the subscriber can use the computer on-line system without worrying about the cost.

A cable modem is required when a system using a CATV line is to be built. This cable modem is more expensive than a general modem. Also, in contrast to a general public switched telephone network that has the infrastructure already equipped, investment to lay down a CATV line network is required. Such infrastructure must be maintained and investment for maintenance thereof is required. These disadvantages attribute to delaying implementation of a high speed communication system through a CATV line. Even the system disclosed in the aforementioned publication cannot solve these issues.

### SUMMARY OF THE INVENTION

An object of the present invention is to provide a data communication apparatus and data communication computer that can easily build a communication system that requires infrastructure maintenance.

Another object of the present invention is to provide a data communication apparatus and data communication system in which the need for the user to bear the expense of building a communication system that requires infrastructure maintenance is low.

A further object of the present invention is to provide a data communication apparatus and data communication computer in which the need for a user to bear the expense of building a communication system is low by providing information to a user that utilizes the network.

Still another object of the present invention is to provide a data communication apparatus and data communication computer in which the need for a user to bear the expense of building a communication system is low by providing information suiting a user utilizing the network.

According to an aspect of the present invention, a data communication apparatus establishes connection a first computer and a second computer. The data communication apparatus includes a reception circuit receiving data from the first computer, a conversion circuit connected to the reception circuit to convert the received data into data for transmission to the second computer, a transmission circuit connected to the conversion circuit to transmit the converted data to the second computer, an output circuit to provide information so as to be recognized by the user of the data communication apparatus, and a control circuit connected to the reception circuit and the output circuit to control the output circuit such that advertisement information included in the data received from the first computer is output to the output circuit.

The data communication apparatus modulates data received from the first computer and transmits the modulated data to the second computer, such as a cable modem. The data communication apparatus extracts and displays advertisement information included in the data transmitted from the first computer. Through this display, the user of the cable modem and the second computer can view the advertisement displayed at the cable modem without depending upon an application in a personal computer. The value corresponding to advertisement information being viewed by a user can be collected from the advertiser. Using the collected value corresponding to an advertisement, the infrastructure can be maintained (cable layout, cable modem purchase). As a result, a data communication apparatus can be provided in which the need for the user to bear such maintenance fee is low.

Preferably, the output circuit can include a circuit that displays data. The control circuit can include a circuit that controls the output circuit such that data is displayed at the output circuit based on advertisement information.

The data communication apparatus can provide a display of advertisement information to the user, and the user can view the advertisement.

Further preferably, the output circuit can include a circuit that outputs a sound. The control circuit can include a circuit that controls the output circuit such that a sound is output by the output circuit based on advertisement information.

The data communication apparatus can provide advertisement information in, for example, synthetic voice to the user, and the user can listen to the advertisement.

Further preferably, the output circuit can include a circuit that displays data. The data communication apparatus can include a circuit to provide an output to prompt a user of the communication apparatus to view advertisement information when advertisement information is displayed at the output circuit.

The data communication apparatus can reliably cause a user to view the advertisement when displayed to the user by sounding a buzzer or the like.

Further preferably, the control circuit includes a circuit to extract advertisement information from data received from the first computer, and a circuit controlling the output circuit such that extracted advertisement information is output to the output circuit.

The advertisement information can be included in general data transmitted to the second computer, and transmitted to the data communication apparatus from the first computer.

Further preferably, the control circuit includes a circuit extracting advertisement information from data received from the first computer based on a frequency bandwidth where data is transmitted, and a circuit controlling the output circuit such that extracted advertisement information is output to the output circuit.

The general data transmitted to the second computer and the advertisement information can be transmitted from the first computer to the data communication apparatus with the frequency bandwidth discriminated. For example, one empty channel among the communication channels from the first computer to the data communication apparatus can be specified as a dedicated channel for advertisement information transmission.

Further preferably, the control circuit includes a circuit extracting advertisement information from data received from the first computer based on the type of communication line with the first data communication apparatus, and a circuit controlling the output circuit such that extracted advertisement information is output to the output circuit.

Connection is established between the first computer and the data communication apparatus through a cable television line, a general telephone line, a digital telephone line, or the like. Advertisement information can be transmitted from the first computer to the data communication apparatus through a communication line differing from that through which data is transmitted to the second computer.

Further preferably, the first computer is connected by at least one of a cable television line, a general telephone line, and a digital telephone line.

The data communication apparatus and the first computer are connected through a cable television line, a general telephone line, and a digital telephone line to realize high speed communication.

Further preferably, data is communicated with the first computer using any of a voice conversation bandwidth and a frequency bandwidth higher than the voice conversation bandwidth.

The data communication apparatus and the first computer can realize high speed communication using a frequency bandwidth higher than the voice conversation bandwidth in a general telephone line.

Further preferably, the data communication apparatus can further include a storage circuit connected to the reception circuit to store advertisement information, and a schedule data reception circuit receiving schedule data representing the output schedule of advertisement information from the first computer. The control circuit can include a circuit controlling the output circuit such that advertisement information is output to the output circuit based on the received schedule data.

The data communication apparatus can have advertisement information prestored, and output the stored advertisement information based on the schedule data received from the first computer.

Further preferably, the data communication apparatus can further include a storage circuit connected to the reception circuit to store advertisement information, and a schedule data generation circuit generating schedule data representing the output schedule of advertisement information. The control circuit can include a circuit controlling the output circuit such that advertisement information is output to the output circuit based on the generated schedule data.

The data communication apparatus can have advertisement information prestored, and output the stored advertisement information based on the generated schedule data.

Further preferably, the data communication apparatus can further include an input circuit for a user of the data communication apparatus to input affirmation information indicating that output of advertisement information from the output circuit has been affirmed, and an affirmation information transmission circuit connected to the input circuit to transmit the input affirmation information to the first computer.

The data communication apparatus can transmit affirmation information input when a user of the data communication apparatus views an advertisement to the first computer. The amount borne by the user can further be reduced by collecting a high advertisement fee for advertisement information viewed by the user at the first computer or the like.

Further preferably, the data communication apparatus can further include an input circuit for a user of the data communication apparatus to input request information requesting information related to advertisement information based on the advertisement information output by the output circuit, a request transmission circuit connected to the input circuit to transmit the input request information to the first computer, and a request information control circuit controlling the output circuit such that related information transmitted from the first computer is output in response to the request information.

The user of the data communication apparatus inputs the request information when the user wishes to view related information including further detailed information and the like of the displayed advertisement information. The data communication apparatus transmits the input request information to the first computer, and displays the related information transmitted from the first computer. The amount to be borne by the user can further be reduced by collecting a high advertisement fee for the advertisement information of which related information is requested by the user at the first computer or the like.

Further preferably, the data communication apparatus can further include a storage circuit to store advertisement information. The advertisement information can include first advertisement data representing the contents of an advertisement, and second advertisement data to retrieve the first advertisement data. The output circuit can include a circuit displaying the second advertisement data. The data communication apparatus can further include an input circuit for a user of the data communication apparatus to input the second advertisement data, and a retrieval circuit connected to the storage circuit and the input circuit to retrieve the first advertisement data based on the second advertisement information input by the user. The output circuit can include a circuit that displays the first advertisement data retrieved by the retrieval circuit.

The user of the data communication apparatus can have the first advertisement data of interest to the user retrieved and displayed based on the displayed second advertisement data (for example, index data).

Further preferably, the data communication apparatus can further include a storage circuit to store advertisement information, and a generation circuit generating advertisement retrieval data to retrieve advertisement information based on advertisement information. The output circuit can include a circuit to display advertisement retrieval data. The data communication apparatus can further include an input circuit for the user of the data communication to input advertisement retrieval data, and a retrieval circuit connected to the storage circuit and the input circuit to retrieve advertisement information based on the advertisement retrieval data input by the user. The output circuit can include a circuit displaying advertisement information retrieved by the retrieval circuit.

The data communication apparatus generates advertisement retrieval data (for example, index data) based on advertisement information. The user of the data communication apparatus can have the advertisement information of interest to the user retrieved and displayed based on the displayed advertisement retrieval data.

According to another aspect of the present invention, a data communication computer is connected to a first computer. The data communication computer includes a first instruction circuit instructing the first computer to transmit data including advertisement information to a data communication apparatus establishing connection between first and second computers, and a calculation circuit calculating an accounting amount to be collected from an advertiser of advertisement information.

The data communication computer instructs the first computer to transmit data including advertisement information to the data communication apparatus. The data communication apparatus converts the data received from the first computer and transmits the converted data to the second computer. The data communication apparatus outputs advertisement information included in the data received from the first computer. The data communication computer calculates the accounting amount to be collected from the advertiser of the advertisement information included in the data transmitted to the first computer. The value of having a user view advertisement information is calculated and can be collected from the advertiser. Using the collected value with respect to the advertisement, infrastructure can be maintained (cable layout, cable modem purchase). As a result, a data communication computer in which there is no need for the user to cover the maintenance fee can be provided.

Further preferably, the data communication computer can further include a reception circuit receiving request information from the first computer. The first instruction circuit can include a circuit instructing the first computer to transmit data including advertisement information to the data communication apparatus based on the request information.

The first computer detects the communication traffic between the first and second computers, and transmits request information requesting advertisement information to the data communication computer based on the communication traffic. The data communication computer instructs the first computer to transmit data including advertisement information to the data communication apparatus upon receiving request information transmitted when the communication traffic is light. Accordingly, advertisement information can be transmitted when the downward communication traffic is light.

Further preferably, the data communication computer can further include a reception circuit receiving communication traffic from the first computer. The first instruction circuit can further include a circuit instructing the first computer to transmit data including advertisement information to the data communication apparatus based on the communication traffic.

The first computer detects the communication traffic between the first and second computers, and transmits the communication traffic to the data communication computer. When determination is made that the communication traffic is light, the data communication computer instructs the first computer to transmit data including advertisement information to the data communication apparatus. Accordingly, advertisement information can be transmitted when the downward communication traffic is light.

Further preferably, the data communication computer can further include a second instruction circuit to instruct the first computer to transmit schedule data representing the output schedule of advertisement information to the data communication apparatus. The calculation circuit can include a circuit calculating an accounting amount based on the schedule data.

Based on the schedule data transmitted to the data communication apparatus, advertisement information is displayed at the data communication apparatus, and the user views the advertisement. The data communication computer can calculate the accounting amount based on the schedule data so that the advertisement fee for advertisement information displayed at a time zone of high viewing probability is set higher.

Further preferably, the data communication computer can further include a detection circuit detecting affirmation information. The calculation circuit can include a circuit calculating an accounting amount based on the affirmation information.

The data communication apparatus transmits affirmation information indicating that the user of the data communication apparatus has viewed the advertisement information to the second computer. The data communication computer can calculate the accounting amount based on the affirmation information so that the advertisement fee for advertisement information viewed by the user of the data communication apparatus is set higher.

Further preferably, the data communication computer can further include a detection circuit detecting request information, and a second instruction circuit connected to the detection circuit and the first computer to instruct the first computer to transmit related information to the data communication apparatus.

When the user of the data communication apparatus wishes to view related information including further detailed information or the like of the displayed advertisement information, the user inputs request information. The data communication apparatus transmits the input request information to the first computer. The first computer transmits the request information to the data communication computer. The data communication computer instructs the first computer to transmit related information to the data communication apparatus upon detection of request information. The data communication apparatus can display the related information transmitted from the first computer. Accordingly, the user can be made to view detailed information stored in the data communication computer corresponding to the user's request.

Further preferably, the calculation circuit can include a circuit calculating an accounting amount based on the request information.

The data communication computer can further reduce the amount to be borne by the user by collecting a higher advertisement fee for advertisement information of which related information is requested by the user based on the request information.

Further preferably, the data communication computer can further include a fee calculation circuit calculating the fee to use the line between the first and second computers, based on the accounting amount. The usage fee is to be paid by the user of the second computer.

The accounting amount to be collected from an advertiser can be appropriated entirely or partially for the fee to be paid by the user of the second computer, and reduce the fee to be paid by the user to use the line.

Further preferably, the data communication computer further includes a fee calculation circuit calculating, based on an accounting amount, the fee to use the data communication apparatus that establishes connection between the first computer and the second computer, paid by the user of the second computer.

The accounting amount to be collected by the advertiser can be partially or entirely appropriated for the fee to be paid by the user of the second computer, and reduce the fee to be paid by the user to use the data communication apparatus.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 represents an entire structure of a communication system according to an embodiment of the present invention.

FIG. 2 is a control block diagram of the CMTS in FIG. 1.

FIG. 3 is a control block diagram of a computer system realizing the advertisement server computer of FIG. 1.

FIG. 4 is a control block diagram of the modem in FIG. 1.

FIG. 5 represents advertisement data transmitted from the advertisement server computer to a modem.

FIG. 6 represents advertisement control data (start) transmitted from the advertisement server computer to a modem.

FIG. 7 represents advertisement control data (end) transmitted from the advertisement server computer to a modem.

FIG. 8 represents advertisement control data (erase) transmitted from the advertisement server computer to a modem.

FIG. 9 represents advertisement control data (schedule) transmitted from the advertisement server computer to a modem.

FIG. 10 represents a data structure of advertisement control data (schedule).

FIG. 11 represents an advertisement history database stored in a modem.

FIG. 12 represents first example of a discount rate database stored in the advertisement server computer.

FIG. 13 represents a first example of an advertisement fee database stored in the advertisement server computer.

FIGS. 14A and 14B represent a first example of flow charts of a data process control procedure executed by the CMTS.

FIG. 15 is a first example of a flow chart of a transmission process control procedure executed by the advertisement server computer.

FIGS. 16A and 16B are flow charts of a reception process control procedure executed by a modem.

FIGS. 17A and 17B are flow charts of a display process control procedure executed by a modem.

FIG. 18 is a flow chart of a fee calculation process control procedure executed by the advertisement server computer.

FIG. 19 is a flow chart of a fee calculation process control procedure executed by the CMTS.

FIG. 20 represents an advertisement fee table stored in the advertisement server computer.

FIG. 21 represents a communication channel in a data communication system.

FIG. 22 represents advertisement data (with index) transmitted from the advertisement server computer to a modem.

FIG. 23 is a flow chart of a retrieval process control procedure executed by a modem.

FIG. 24 represents an example of a display at a display unit of a modem.

FIG. 25 represents a related information database stored in the advertisement server computer.

FIG. 26 represents a second example of a discount rate database stored in the advertisement server computer.

FIG. 27 is a second example of an advertisement fee database stored in the advertisement server computer.

FIG. 28 is a flow chart of a request process control procedure executed by a modem.

FIGS. 29A and 29B are a second example of flow charts of a data process control procedure executed by a CMTS.

FIG. 30 is a second example of a flow chart of a transmission process control procedure executed by an advertisement server computer.

FIGS. 31-33 represent the connection status between a modem and a display terminal that communicates with the modem to display advertisement information.

### DESCRIPTION OF THE PREFERRED EMBODIMENTS

Embodiments of the present invention will be described hereinafter with reference to the drawings. In the following description and drawings, the same components have the same reference characters allotted. Their labels and functions are the same. Therefore, detailed description thereof will not be repeated. In the following, description is based on a modem as an example of a data communication apparatus and an advertisement server computer as an example of a data communication computer.

First Embodiment

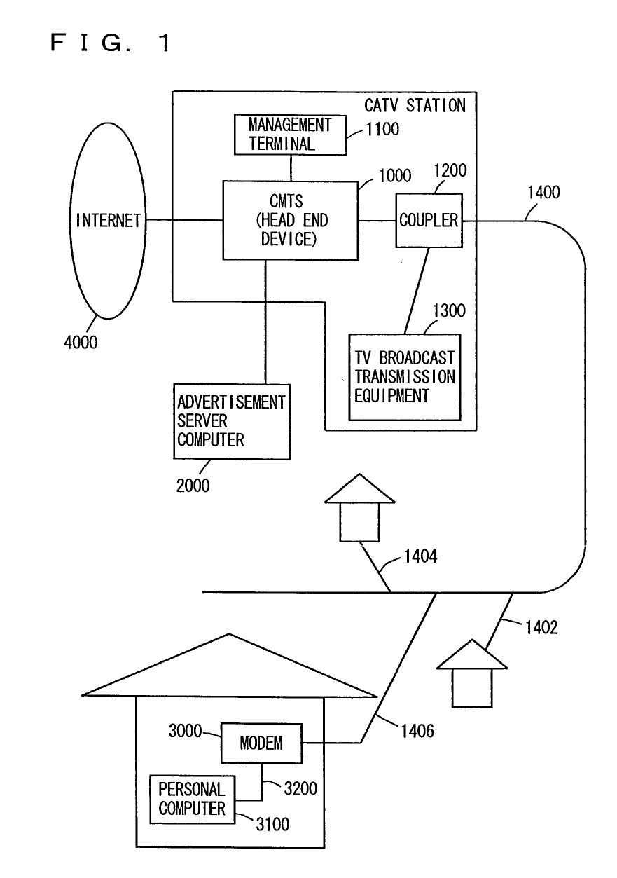

An entire structure of a communication system according to a first embodiment will be described with reference to FIG. 1. The communication system of the present embodiment provides communication between the Internet 4000 and a modem 3000 of a user that receives service from a CATV business proprietor through a CMTS 1000 installed at a CATV station.

At the CATV station are installed CMTS 1000, a management terminal 1100 connected to CMTS 1000 for management thereof, TV broadcast transmission equipment 1300, and a coupler 1200 connected to CMTS 1000 and TV broadcast transmission equipment 1300. CMTS 1000 is connected to Internet 4000 as well as to an advertisement server computer 2000.

At the premises of a user are installed a modem 3000 connected to CMTS 1000 via coupler 1200 and a CATV line 1400, and a personal computer 3100 connected with modem 3000 through an UTP (Unshield Twisted Pair) line 3200.

CATV line 1400 connects a CATV station with the user's premises through an optical fiber or a coaxial cable. CATV line 1400 is branched (CATV lines 1402-1406) in the course of its path to be shared by a plurality of subscribers. The flow of data from CMTS 1000 to the user's residence is called “downstream communication” whereas the flow of data from the user's residence towards CMTS 1000 is called “upstream communication”.

The frequency bandwidth for downstream data communication on CATV line 1400 is selected and set by a CATV service provider from an available empty channel among the channel in the 6 MHz bandwidth for analog TV broadcasting. This channel is common to a plurality of users. Upstream data communication is effected through a channel selected by the CATV service provider in a frequency bandwidth lower than the bandwidth for analog TV broadcasting. In addition to the above-described system, a system carrying out upstream data communication alone through a general telephone line is known.

Prior to initial usage of modem 3000, communication is effected for initialization between modem 3000 and CMTS 1000 located at the CATV station. This communication includes the steps of obtaining information such as the frequency bandwidth to be used for downstream and upstream data communication, adjusting the transmission power, and obtaining network information such as an IP address. Accordingly, personal computer 3100 located at the user's residence is connected to the Internet 400 via modem 3000, CATV line 1400 and CMTS 1000 to allow data communication.

First, upstream communication will be described. Consider the case where data is transmitted from personal computer 3100 at a user's residence to Internet 4000. An upstream data packet in a format compatible to IEEEE 802.3 is transmitted from personal computer 3100 to modem 3000. Modem 3000 converts the upstream transmission packet so as to suit transmission by CATV line 1400 without altering the contents. At this stage, redundant data is added for detection and correction of an error occurring on the CATV line. This upstream transmission packet is sent to CMTS 1000. CMTS 1000 demodulates the received upstream transmission packet and conducts error detection and correction. Data is converted to obtain upstream data. If the destination of the upstream data is Internet 4000, CMTS 1000 sends the data to Internet 4000. Thus, the communication data from a user is transmitted to Internet 4000.

Since CATV line 1400 is shared by a plurality of users, modem 3000 dispatches a transmission request of upstream data to CMTS 1000 prior to transmission of upstream data in order to prevent data collision on CATV line 1400 caused by simultaneous transmission of upstream data. Based on the upstream data transmission requests, CMTS 1000 determines the time when the modem should effect transmission, and sends an upstream data transmission permit to modem 3000. Modem 3000 can transmit upstream data only during the allotted period of time according to the transmission permit from CMTS 1000.

Next, downstream communication will be described. Consider the case where data is to be transmitted from Internet 4000 to personal computer 3100 located at a user's residence. Downstream data is transmitted from Internet 4000 to CMTS 1000. CMTS 1000 generates a downstream transmission packet with a redundant code added for error detection and correction. CMTS 1000 converts the generated downstream transmission packet into signals suiting transmission through CATV line 1400. Coupler 1200 couples the downstream transmission packet received from CMTS 1000 with a signal for analog TV broadcasting, transmitted from TV broadcast transmission equipment 1300. The coupled downstream transmission packet and signal are dispatched on CATV line 1400.

Since the CATV line is shared by a plurality of users, each user will be delivered a transmission packet addressed to another user. The communication data is encrypted using an encryption key generated from a number unique to the modem of the subscriber so that communication data addressed to another user will not be decoded improperly.

The downstream transmission packet distributed to the user's residence through CATV line 1400 is demodulated by modem 3000 to be converted into downstream data. If the destination of the downstream data matches personal computer 3100 of the user, the downstream data is converted into a downstream data packet in a format compatible to IEEE 802.3 since the data is communication data directed to the user. The converted downstream data packet is sent onto UTP line 3200. The sent downstream data packet is transmitted to personal computer 3100 and output through a predetermined application executed at personal computer 3100.

Modem 3000 is continuously active irrespective of the activation status of the user's personal computer and the data communication application on personal computer 3100. Modem 3000 constantly conducts communication of management data to/from CMTS 1000. This management data includes the aforementioned data for initialization of modem 3000, an upstream data transmission request, an upstream data transmission permit, and the like.

Thus, the user has personal computer 3100 constantly connected with Internet 4000 by means of CMTS 1000, CATV line 1400 and modem 3000 for communication.

In the communication system of the present embodiment, CMTS 1000 is connected to an advertisement server computer 2000 installed inside or outside the CATV station. Advertisement server computer 2000 transmits advertisement information to modem 3000 based on a request from CMTS 1000. The advertisement information transmitted to modem 3000 is displayed on a display unit in modem 3000, whereby the user can view the advertisement.

Advertisement server computer 200 calculates the value of the advertisement displayed at modem 3000 being viewed by the user as the advertisement fee. The calculated advertisement fee is collected from the advertiser. The collected advertisement fee is appropriated for the modem usage fee and CATV line usage fee paid by the user. Therefore, the communication fee to be paid by the user is alleviated.

Each component in such a communication system will be described hereinafter.

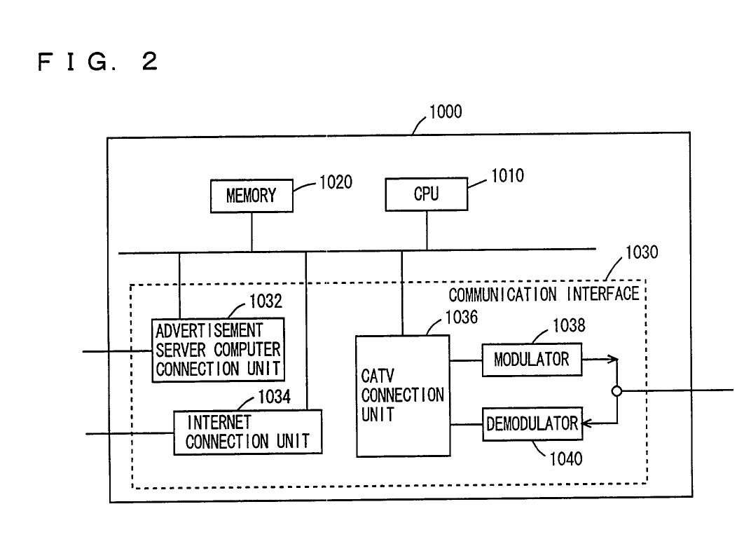

Referring to FIG. 2, the control block of CMTS 1000 in FIG. 1 will be described. CMTS 1000 includes a CPU (Central Processing Unit) 1010 providing the control of each element in CMTS 1000, a memory 1020 storing a program executed by CPU 1010 as well as intermediate data during execution of that program, and a communication interface 1030 connected to CPU 1010 and memory 1020. Communication interface 1030 includes an advertisement server computer connection unit 1032 connected to advertisement server computer 2000, an Internet connection unit 1034 connected to Internet 4000, a CATV connection unit 1036, a modulator 1038 connected to CATV connection unit 1036 to modulate a downstream data packet into a transmission packet suitable for communication through CATV line 1400, and a demodulator 1040 connected to CATV connection unit 1036 to demodulate an upstream transmission packet received via CATV line 1400.

CPU 1010 has the capability of distributing the data received via CATV line 1400 according to the destination included in the header of the received data, transmitting data received from advertisement server computer 2000 and data received from Internet 4000 to a predetermined modem 3000, and controlling the elements of memory 1020 and communication interface 1030.

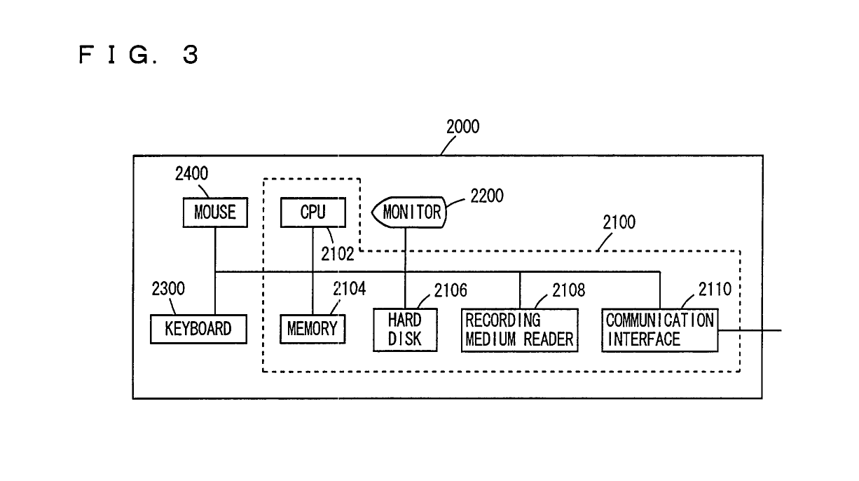

The control block of advertisement server computer 2000 in FIG. 1 will be described with reference to FIG. 3. Advertisement server computer 2000 is embodied by a general computer system. Advertisement server computer 2000 includes a computer 2100, a monitor 2200, a keyboard 2300, and a mouse 2400. Computer 2100 includes a CPU 2102 controlling each element of computer 2100, a memory 2104 storing a program executed by CPU 2102 and intermediate data during execution of that program, a hard disk 2106 storing various databases, a recording medium reader 2108 reading various recording media, and a communication interface 2100 for communication with CMTS 1000. A discount rate database and advertisement fee database are stored in hard disk 2106. The details of these databases will be described afterwards.

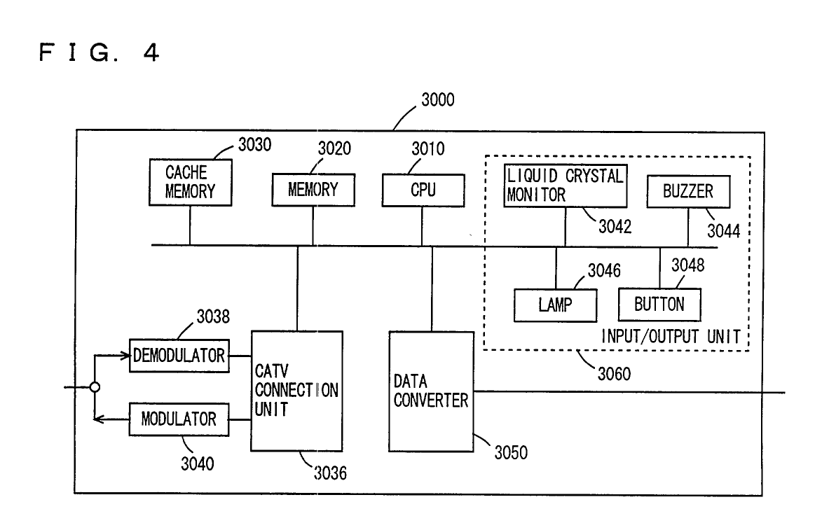

The control block of modem 3000 in FIG. 1 will be described with reference to FIG. 4. Modem 3000 includes a CPU 3010 controlling each element of modem 3000, a memory 3020 storing a program executed by CPU 3010 and intermediate data by that program, a cache memory 3030 storing advertisement data received from CMTS 1000, a CATV connection unit 3036 connected to demodulator 3038 and modulator 3040 that are connected to CATV line 1400, a data converter 3050 connected to personal computer 3100 via UTP line 3200, and an input/output unit 3060.

Input/output unit 3060 includes a liquid crystal monitor 3042 to display advertisement data, a buzzer sounded to attract attention to prompt viewing when advertisement data is displayed on liquid crystal monitor 3042, a lamp 3046 indicating that the user can input view affirmation, and a button 3048 for the user to input indication that the advertisement has been viewed.

A modem ID (identification) to identify one modem from a plurality of modems 3000 connected to CATV line 1400 is stored in memory 3020. Demodulator 3038 demodulates the downstream data packet received from CMTS 1000 via CATV line 1400. Modulator 3040 modulates the upstream data received from personal computer 3100 into an upstream transmission packet suitable to CATV line 1400. Schedule data representing the schedule to display advertisement data on liquid crystal monitor 3042 and an advertisement history database are stored in memory 3020. The details of the schedule data and advertisement history database will be described afterwards.

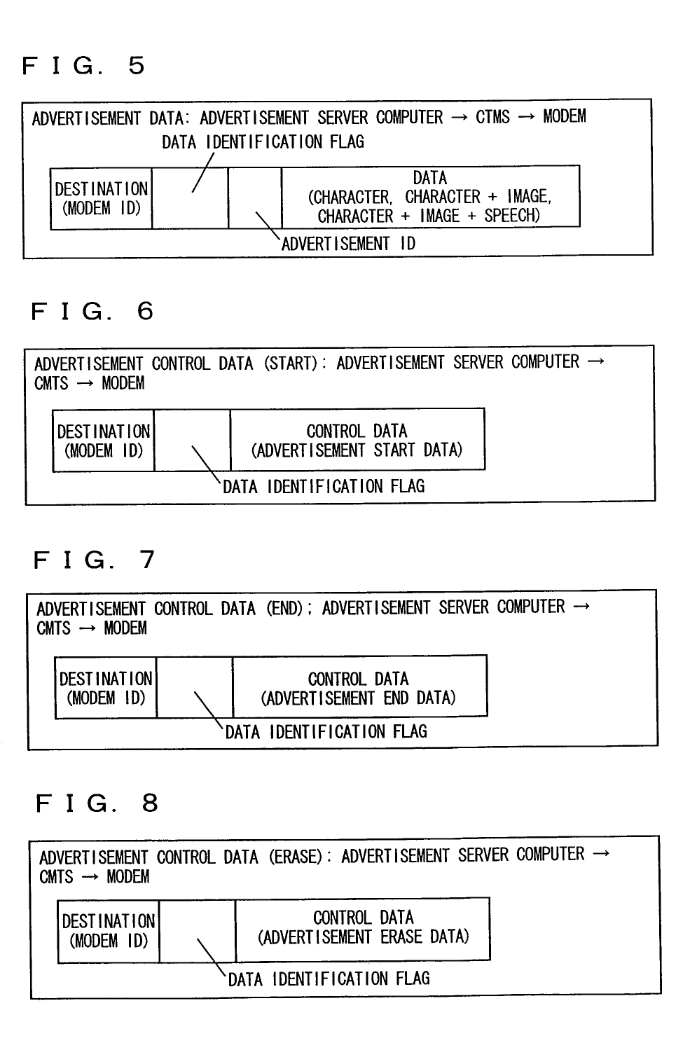

Data transmitted from advertisement server computer 2000 to modem 3000 via CMTS 1000 will be described with reference to FIGS. 5-9.

Referring to FIG. 5, advertisement data transmitted from advertisement server computer 2000 to modem 3000 includes a destination (a modem ID), a data identification flag, an advertisement ID and data. The data can include data of characters alone, data formed of characters and images, and data formed of characters, images, and voice. The modem ID to which advertisement data is transmitted is set as the destination. One modem is identified from a plurality of modems 3000 that share CATV line 1400. The data identification flag identifies the type of data transmitted. The advertisement ID can identify one advertisement from a plurality of advertisements.

Referring to FIG. 6, advertisement control data (start) transmitted from advertisement server computer 2000 to modem 3000 will be described. Advertisement control data (start) is control data to commence display of advertisement data at modem 3000. Advertisement control data (start) includes a destination (modem ID), a data identification flag, and control data (advertisement start data). Upon receiving this advertisement control data (start), modem 3000 initiates the display of advertisement data through liquid crystal monitor 3042. Advertisement control data (start) is transmitted when arriving at the time when the user looks at liquid crystal monitor 3042 (for example, 7:00 p. m.).

Referring to FIG. 7, advertisement control data (end) transmitted from advertisement server computer 2000 to modem 3000 will be described. Advertisement control data (end) is the control data to end the display of advertisement data at modem 3000. Advertisement control data (end) includes a destination (modem ID), a data identification flag, and control data (advertisement end data). This advertisement control data (end) is transmitted when arriving at the time when the user will not look at liquid crystal monitor 3042 of modem 3000 (for example, 2:00 a. m.).

By appropriately combining the advertisement control data (start) and advertisement control data (end) of FIG. 6, display of an advertisement at liquid crystal monitor 3042 during a time zone in which the user will not view the advertisement information displayed on liquid crystal monitor 3042 of modem 3000 can be suppressed.

Referring to FIG. 8, advertisement control data (erase) transmitted from advertisement server computer 2000 to modem 3000 will be described. Upon receiving this control data, modem 3000 erases advertisement data stored in cache memory 3030. Advertisement control data (erase) includes a destination (modem ID), a data identification flag, and control data (advertisement erase data). This advertisement control data is written with an instruction to erase all or a part of advertisement data stored in cache memory 3030.

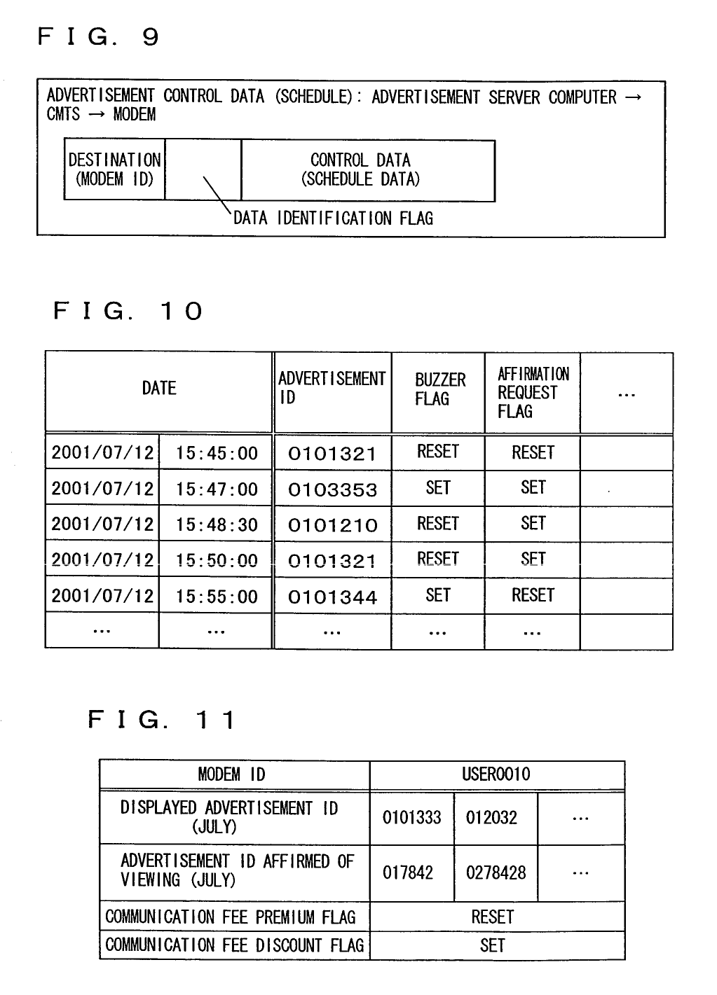

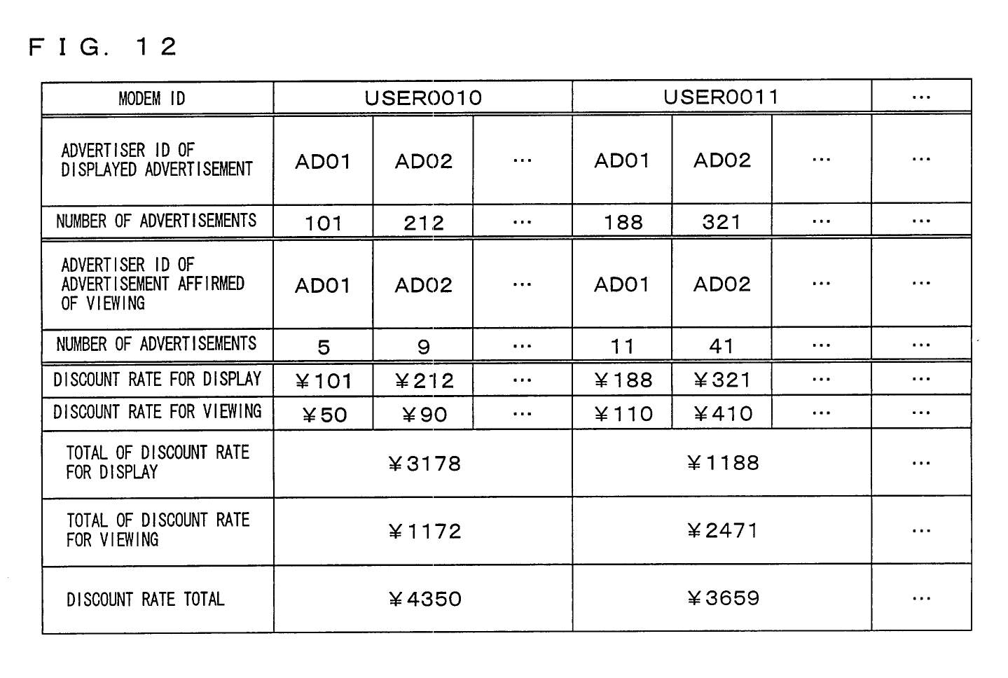

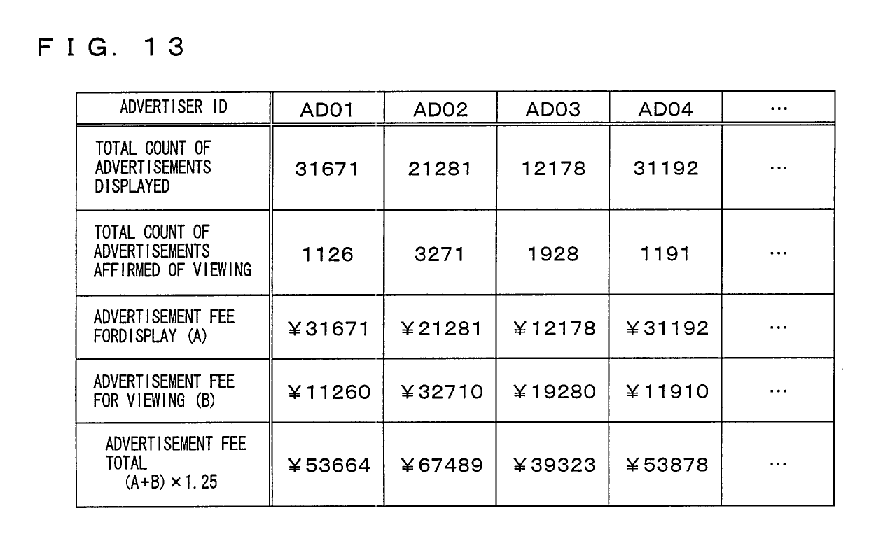

Advertisement control data (schedule) transmitted from advertisement server computer 2000 to modem 3000 will be described with reference to FIG. 9. Upon receiving this control data, modem 3000 stores the received control data in memory 3020, and displays advertisement data on liquid crystal monitor 3042 in a predetermined order based on the schedule data and detected current time. The advertisement control data (schedule) includes a destination (modem ID), a data identification flag and control data (schedule data).

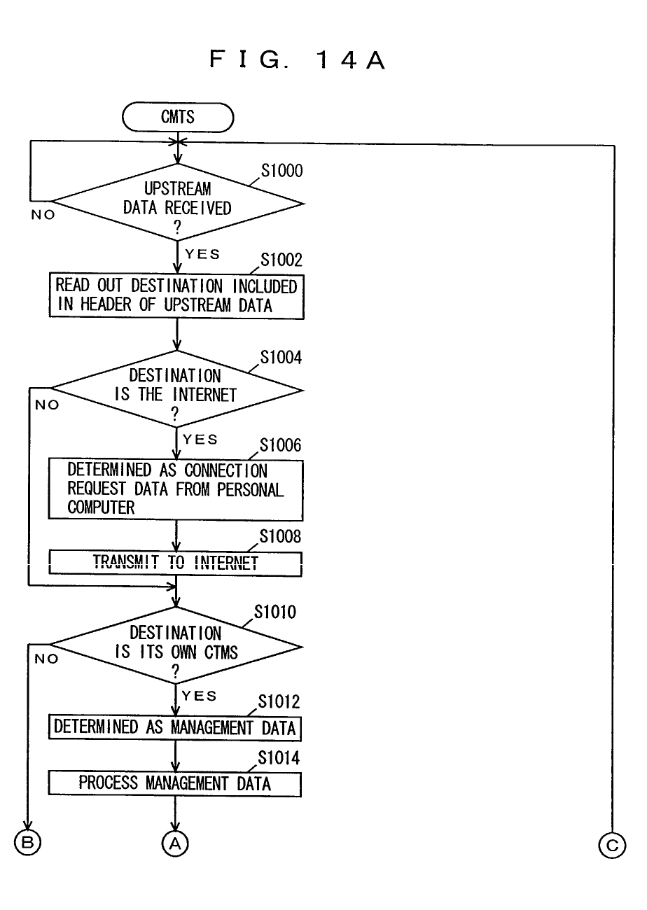

The details of schedule data will be described with reference to FIG. 10. The schedule data stores an advertisement ID, a buzzer flag, and an affirmation request flag for each date. The buzzer flag is a flag to determine whether to sound buzzer 3044 when advertisement data is displayed on liquid crystal monitor 3042. The affirmation request flag is a flag to indicate whether the user is requested to affirm viewing of the advertisement displayed on liquid crystal monitor 3042.

When the buzzer flag is set, buzzer 3044 is sounded when advertisement information is displayed on liquid crystal monitor 3042. When the affirmation request flag is set, lamp 3046 is turned on when advertisement data is displayed on liquid crystal monitor 3042. If the affirmation button is pressed through button 3048 when lamp 3046 is on, data that affirms viewing is transmitted from modem 3000 to CMTS 1000.

Referring to FIG. 11, the advertisement history database stored in memory 3020 will be described. The advertisement history database stores the advertisement ID that is displayed, and the advertisement ID that is affirmed of viewing on a monthly basis. Also, a communication fee premium flag and a communication fee discount flag are stored. The communication fee premium flag is set when there is no advertisement that is affirmed of viewing even though there are a plurality of advertisement IDs displayed. The communication fee discount flag is set when viewing at least one advertisement is affirmed in the case where there are a plurality of advertisement IDs displayed. Specifically, in the case where a plurality of advertisements are displayed on display monitor 3042 of modem 3000, the communication fee is set with a premium when viewing has not being affirmed and set with a discount when viewing has been affirmed.

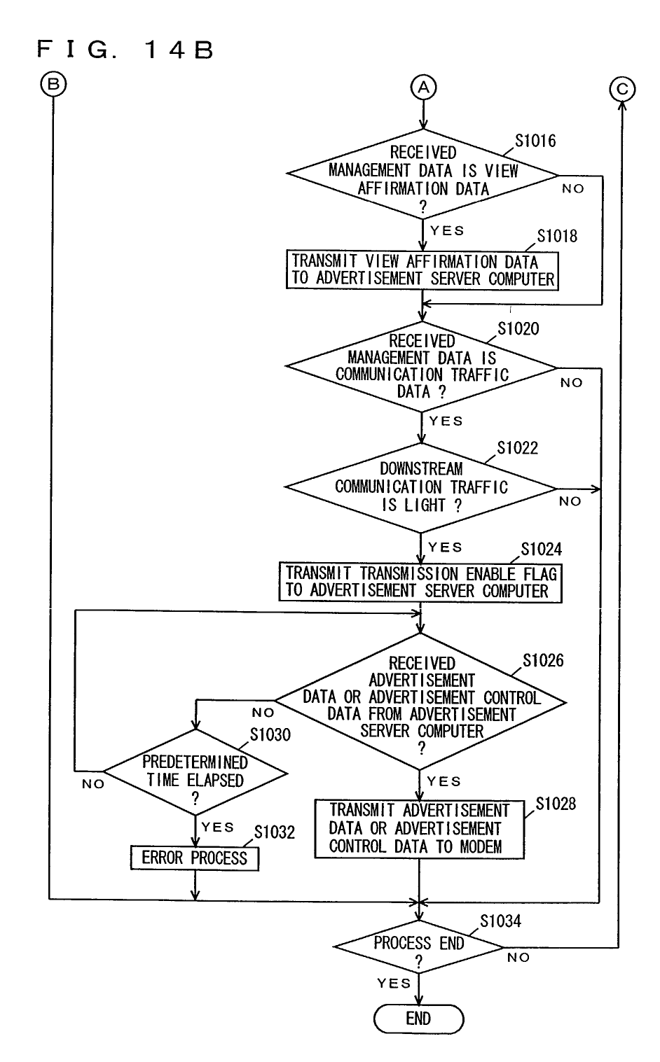

Referring to FIG. 12, the discount rate database stored in hard disk 2106 of advertisement server computer 2000 will be described. The discount rate database stores an advertiser ID of the displayed advertisement, the number of advertisements thereof, the advertiser ID of the advertisement that has been affirmed of viewing, and the number of advertisements thereof for each modem ID. Also, the discount rate for display and the discount rate for viewing are stored for each modem ID. Furthermore, the total of the discount rate for display which is the sum of the discount rate for display, stored for each advertiser ID, and the total of the discount rate for viewing, which is the sum of the discount rate for viewing stored for each advertiser ID, are stored. Additionally, a discount rate total amount which is the sum of the discount rate total for display and the discount rate total for viewing is stored. For example, it is assumed that the discount rate for display per one advertisement is one yen, and the discount rate for viewing is calculated as five yen per one advertisement. Referring to the modem ID of “USER0010”, for example, the total of the discount rate for display, 3078 yen, plus the total of the discount rate for viewing, 1172 yen, i.e., the total of 4350 yen, is stored as the discount rate.

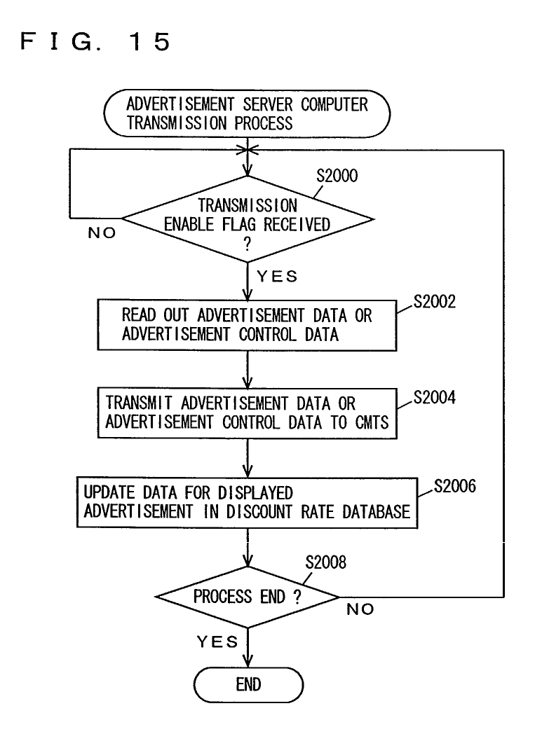

Referring to FIG. 13, the advertisement fee database stored in hard disk 2106 of advertisement server computer 2000 will be described. The advertisement fee database stores the total number of advertisements displayed at a plurality of modems 3000, and the total of a number of advertisements affirmed of viewing for each advertiser ID. Also, the advertisement fee calculated based on the total count of advertisement displayed, and the advertisement fee calculated based on the number of advertisements affirmed of viewing are stored. The advertisement fee total which is the advertisement fee for display plus the advertisement fee for viewing is stored. For the advertiser ID of “AD01”, for example, the total count of the number of advertisements displayed is 31671, so that the advertisement fee for display is calculated and stored as 31671 yen. The total of the count of advertisements affirmed of viewing is 1126, and the advertisement fee for viewing is calculated and stored as 11260 yen. Extra charge is added to the total of the advertisement charge. Specifically, the advertisement fee for display, 31671 yen, plus the advertisement fee for viewing, 11260 yen, is increased by 25% as the advertisement fee total. This amount of 25% will be collected by the CATV service provider as the management fee of the CATV service provider.

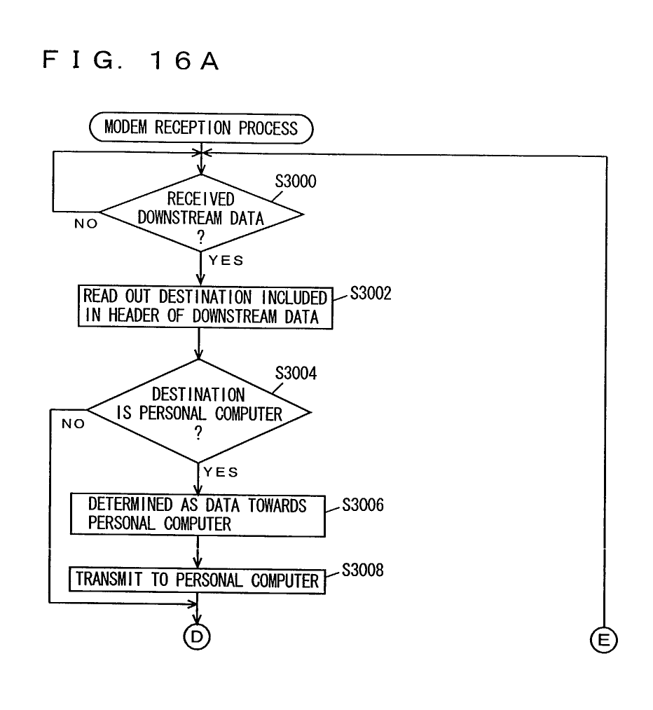

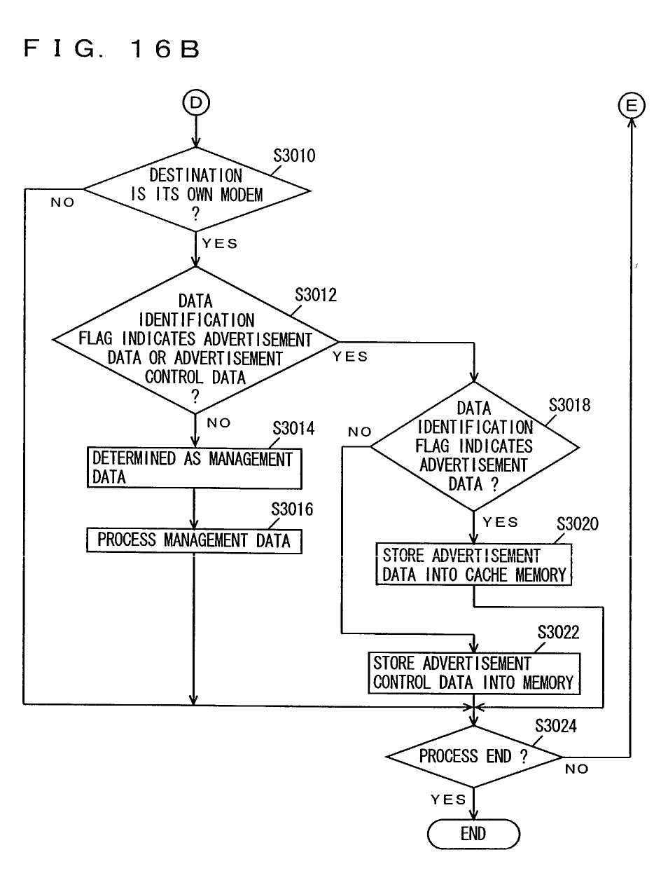

Referring to FIGS. 14A and 14B, the program executed by CMTS 1000 corresponds to a data process. The data process program includes a control structure set forth below.

At step (abbreviated as S hereinafter) 1000, CPU 1010 determines whether upstream data has been received via CATV connection unit 1036. When upstream data has been received (YES at S1000), control proceeds to S1002. When upstream data is not received (NO at S1000), control returns to S1000 to wait for reception of upstream data.

At S1002, CPU 1010 reads out the destination included in the header of the upstream data. At S1004, CPU 1010 determines whether the read out destination is the Internet or not. If the destination is the Internet (YES at S1004), control proceeds to S1006, otherwise (NO at S1004), control proceeds to S1010.

At S1006, CPU 1010 determines whether the received upstream data is connection request data from personal computer 3100. At S1008, CPU 1010 transmits connection request data to Internet 4000. At S1010, CPU 1010 determines whether the read out destination is its own CMTS 1000. When the destination is its own CMTS 1000 (YES at S1010), control proceeds to S1012, otherwise (NO at S1010), control proceeds to S1034.

At S1012, CPU 1010 determines that the received upstream data is management data. At S1014, CPU 1010 processes the management data. At S1016, CPU 1010 determines whether the received management data is view affirmation data or not. This determination is based on the data identification flag included in the received management data. When the received management data is view affirmation data (YES at S1016), control proceeds to S1018, otherwise (NO at S1016), control proceeds to S1020.

At S1018, CPU 1010 transmits the view affirmation data to advertisement server computer 2000.

At S1020, CPU 1010 determines whether the received data is communication traffic data or not. When the received management data is communication traffic data (YES at S1020), control proceeds to S1022, otherwise (NO at S1020), control proceeds to S1034.

At S1022, CPU 1010 determines whether the downstream communication traffic is light or not. This determination is based on whether the communication traffic is lighter than a predetermined traffic amount. When the downstream communication traffic is light (YES at S1022), control proceeds to S1024, otherwise (NO at S1022), control proceeds to S1034.

At S1024, CPU 1010 transmits a transmission enable flag to advertisement server computer 2000.

At S1026, CPU 1010 determines whether advertisement data or advertisement control data has been received from advertisement server computer 2000. When advertisement data or advertisement control data has been received from advertisement server computer 2000 (YES at S1026), control proceeds to 1028, otherwise (NO at S1026), control proceeds to S1030.

At S1023, CPU 1010 transmits advertisement data or advertisement control data to modem 3000.

At S1030, CPU 1010 determines whether a predetermined time has elapsed since a transmission enable flag has been transmitted to advertisement server computer 2000. When a predetermined time has elapsed (YES at S1030), control proceeds to S1032, otherwise (NO at S1030), control proceeds to S1026.

At S1032, CPU 1010 conducts an error process. The error process at S1032 indicates the occurrence of trouble in the communication with advertisement server computer 2000 on, for example, the monitor of a management terminal 100 connected to CMTS 1000.

At S1034, CPU 1010 determines whether the CMTS 1000 process is to be terminated or not. When the process of CMTS 1000 is to be terminated (YES at S1034), the process of CMTS 1000 ends, otherwise (NO at S1034), control returns to S1000.

Referring to FIG. 15, the program executed by advertisement server computer 2000 relates to a transmission process. The transmission process program has a control structure set forth below.

At S2000, CPU 2102 determines whether a transmission enable flag has been received from CMTS 1000. When a transmission enable flag has been received (YES at S2000), control proceeds to S2002, otherwise (NO at S2000), control returns to S2000 to wait for reception of a transmission enable flag.

At S2002, CPU 2102 reads out advertisement data or advertisement control data from hard disk 2106. At S2004, CPU 2102 transmits advertisement data or advertisement control data to CMTS 1000.

At S2006, CPU 2102 updates the data for advertisements displayed in the discount rate database (FIG. 12). At S2008, CPU 2102 determines whether to end the process of advertisement server computer 2000. When the process is to be terminated (YES at S2008), the transmission process of advertisement server computer 2000 ends, otherwise (NO at S2008), control returns to S2000.

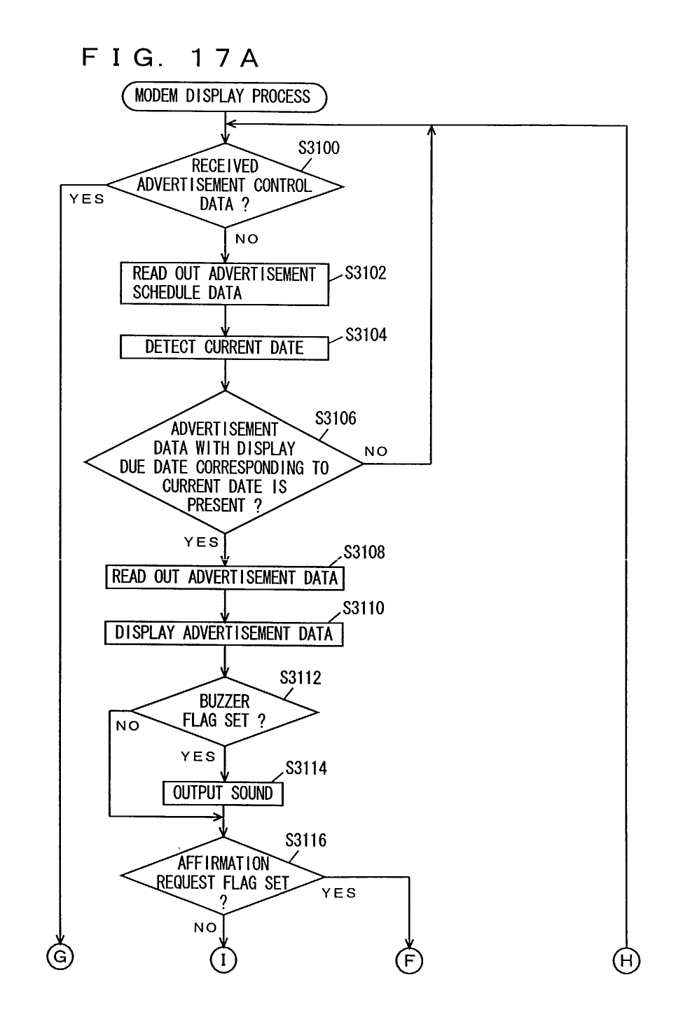

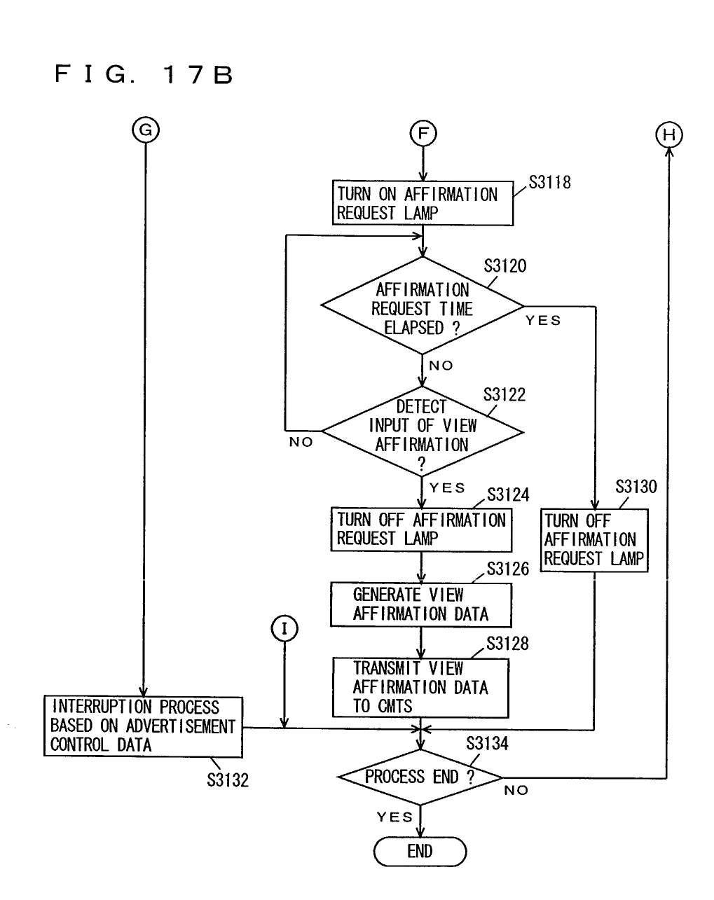

Referring to FIGS. 16A and 16B, the program executed at modem 3000 relates to a reception process. The reception process program has a control structure set forth below.

At S3000, CPU 3010 determines whether downstream data has been received or not via CATV connection unit 3036. When downstream data has been received (YES at S3000), control proceeds to S3002, otherwise (NO at S3000), control returns to S3000 to wait for reception of downstream data.

At S3002, CPU 3010 reads out the destination included in the header of the downstream data. At S3004, CPU 3010 determines whether the read out destination is personal computer 3100 or not. When the destination matches personal computer 3100 (YES at S3004), control proceeds to S3006, otherwise (NO at S3004), control proceeds to S3010.

At S3006, CPU 3010 determines that the received downstream data is data directed towards personal computer 3100. At S3008, CPU 3010 transmits the received data to personal computer 3100.

At S3010, CPU 1010 determines whether the destination is its own modem 3000 or not. When the destination is its own modem 3000 (YES at S3010), control proceeds to S3012, otherwise (NO at S3010), control proceeds to S3024.

At S3012, CPU 3010 determines whether the data identification flag indicates advertisement data or advertisement control data. When the data identification flag indicates advertisement data or advertisement control data (YES at S3012), control proceeds to S3018, otherwise (NO at S3012), control proceeds to S3014.

At S3014, CPU 3010 determines that the received downstream data is management data. At S3016, CPU 3010 processes the management data. Then, control proceeds to S3024.

At S3018, CPU 3010 determines whether the data identification flag indicates advertisement data or not. When the data identification flag indicates advertisement data (YES at S3018), control proceeds to S3020, otherwise (NO at S3018), control proceeds to S3022.

At S3020, CPU 3010 stores the received advertisement data into cache memory 3030.

At S3022, CPU 3010 stores advertisement control data into memory 3020. At S3024, CPU 3010 determines whether the process at modem 3000 is to be ended or not When the process is to be terminated (YES at S3024), the transmission process of modem 3000 is terminated, otherwise (NO at S3024), the process returns to S3000.

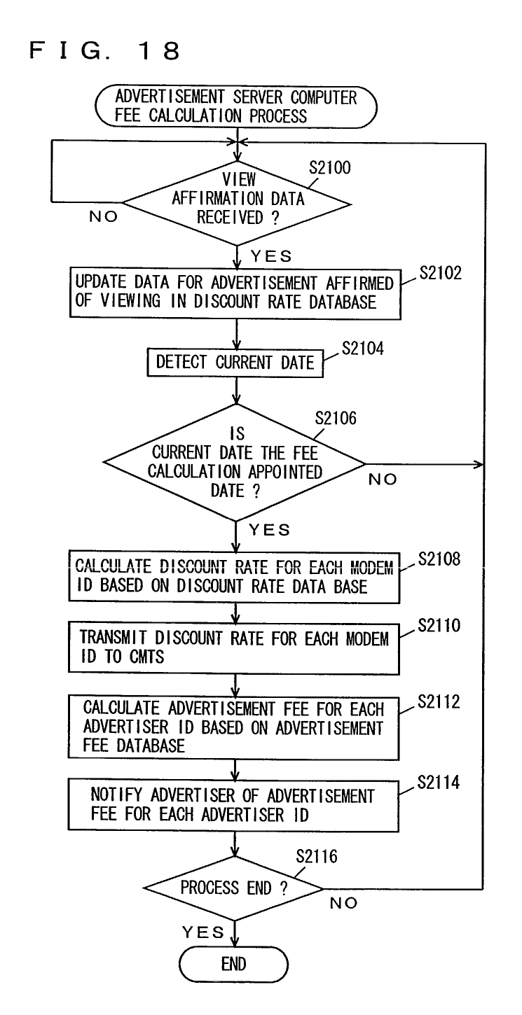

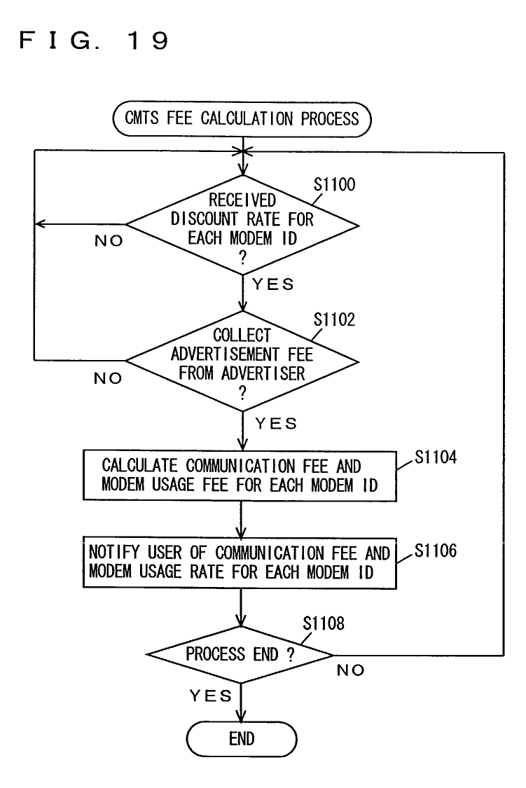

Referring to FIGS. 17A and 17B, the program executed by modem 3000 relates to a display process. The display process program has a control structure set forth below.

At S3100, CPU 3010 determines whether advertisement control data is received via CATV connection unit 3036. When advertisement control data has been received (YES at S3100), control proceeds to S3132, otherwise (NO at S3100), control proceeds to S3102.

At S3102, CPU 3010 reads out advertisement schedule data from memory 3020. At S3104, CPU 3010 detects the current date. At S3106, CPU 3010 determines whether there is advertisement data with a display due date corresponding to the current date. When advertisement data with a display due date corresponding to the current date is present (YES at S3106), control proceeds to S3108, otherwise (NO at S3106), control returns to S3100.

At S3108, CPU 3010 reads out advertisement data from cache memory 3030. At S3110, control unit 3010 displays the read out advertisement data on liquid crystal monitor 3042. At S3112, CPU 3010 determines whether the buzzer flag is set or not. This determination is based on the schedule data (FIG. 10) stored in memory 3020. When the buzzer flag is set (YES at S3112), control proceeds to S3114, otherwise (NO at S3112), control proceeds to S3116.

At S3114, CPU 3010 issues an attracting sound through buzzer 3044.

At S3116, CPU 3010 determines whether the affirmation request flag is set or not. Similar to the determination of the above S3112, this determination is based on the schedule data (FIG. 10). When the affirmation request flag is set (YES at S3116), control proceeds to S3118, otherwise (NO at S3116), control proceeds to S3134.

At S3118, CPU 3010 turns on lamp 3046 for the affirmation request.

At S3120, CPU 3010 determines whether the affirmation request period has elapsed or not. This determination is based on whether the affirmation request flag is altered from a set state to a reset state according to the schedule data (FIG. 10). When the affirmation request period has elapsed (YES at S3120), control proceeds to S3130, otherwise (NO at S3120), control proceeds to S3122.

At S3122, CPU 3010 determines whether a view affirmation input has been detected through button 3048. When view affirmation input has been detected (YES at S3122), control proceeds to S3124, otherwise (NO at S3122), control proceeds to S3120.

At S3124, CPU 3010 turns off lamp 3046 directed to affirmation request. At S3126, CPU 3010 generates view affirmation data. At S3128, CPU 3010 transmits the view affirmation data to CMTS 1000. At S3130, CPU 3010 turns off the affirmation request lamp.

At S3132, CPU 3010 carries out an interruption process based on the received advertisement control data (start, end, erase). At this stage, an interrupt process corresponding to the contents of the control data is carried out.

At S3134, CPU 3010 determines whether the process of modem 3000 is to be terminated or not. When the process is to be terminated (YES at S3134), the display process of modem 3000 ends, otherwise (NO at S3134), control returns to S3100.

Referring to FIG. 18, the program executed by advertisement server computer 2000 relates to a fee calculation process. The fee calculation process program has a control structure set forth below.

At S2100, CPU 2102 determines whether view affirmation data has been received via communication interface 2110. When view affirmation data has been received (YES at S2100), control proceeds to S2102, otherwise (NO at S2100), control returns to S2100.

At S2102, CPU 2102 updates the data for the advertisement that is affirmed of viewing in the discount rate database (FIG. 12) stored in hard disk 2106. At S2104, CPU 2102 detects the current date. At S2106, CPU 2102 determines whether the current date is the appointed date of fee calculation. When the current date is the fee calculation appointed date (YES at S2106), control proceeds to S2108, otherwise (NO at S2106), control returns to S2100.

At S2108, CPU 2102 calculates the discount rate for each modem ID based on the discount rate database (FIG. 12). At S2110, CPU 2102 transmits the discount rate for each modem ID to CMTS 1000.

At S2112, CPU 2102 calculates the advertisement fee for each advertiser ID based on the advertisement fee database (FIG. 13). At S2114, CPU 2102 notifies the advertiser of the advertisement fee for each advertisement ID. At S2116, CPU 2102 determines whether the process of advertisement server computer 2000 is to be terminated or not. When the process is to be terminated (YES at S2116), the advertisement server computer rate calculation process ends, otherwise (NO at S2116), the process returns to S2100.

Referring to FIG. 19, the program executed by CMTS 1000 relates to a fee calculation process. The fee calculation process program has a control structure set forth below. It is to be noted that the process of the flow chart of FIG. 19 may be executed at CMTS 1000 or at a management terminal 1100 of CMTS 1000. In the following, it is assumed that the program of the flow chart of FIG. 19 is executed by CMTS 1000.

At S1100, CPU 1010 determines whether the discount rate for each modem ID has been received from advertisement server computer 2000. When the discount rate for each modem ID is received (YES at S1100), control proceeds to S1102, otherwise (NO at S1100), control returns to

At S1102, CPU 1010 determines whether the advertisement fee has been collected from the advertiser or not. This determination is based on whether collection accomplished data has been received from an online accounting server connected to the network. When the advertisement fee has been collected from the advertiser (YES at S1102), control proceeds to S1104, otherwise (NO at S1102), control proceeds to S1100.

At S1104, CPU 1010 calculates the communication fee and modem usage fee for each modem ID. At S1106, CPU 110 notifies the user of the communication fee and modem usage fee on a modem ID basis. At S1108, CPU 1010 determines whether the fee calculation process of CMTS 1000 is to be terminated or not When the process is to be terminated (YES at S1108), this CMTS 1000 rate calculation process ends, otherwise (NO at S1108), the process returns to S1100.

The operation of a communication system based on the above-described structure and flow chart will be described hereinafter.

Advertisement Data Transmission Operation

When the downstream communication traffic from CMTS 1000 to modem 3000 is light, CMTS 1000 detects that light downstream communication traffic (YES at S1022), and transmits a transmission enable flag to advertisement server computer 2000 (S1024). When advertisement server computer 2000 receives a transmission enable flag from CMTS 1000 (YES at S2000), advertisement data or advertisement control data is read out from hard disk 2106 (S2002).

Advertisement server computer 2000 transmits the advertisement data or advertisement control data to CMTS 1000 (S2004), and updates the data for the displayed advertisement in the discount rate database (FIG. 12) stored in hard disk 2106 (S2006).

Modem 3000 receives downstream data (YES at S3000), and reads out the destination included in the downstream data (S3002). When the destination is not personal computer 3100 (NO at S3004), but towards its own modem (YES at S3100), and the data identification flag indicates advertisement data or advertisement control data (YES at S3012), the advertisement data is stored in cache memory 3030 (S3020), or advertisement control data is stored in memory 3020 (S3022).

Advertisement Display Operation of Modem

When modem 3000 receives advertisement control data (start) (YES at S3100), an interruption process is carried out according to the control data (S3132). The advertisement display operation at modem 3000 is commenced.

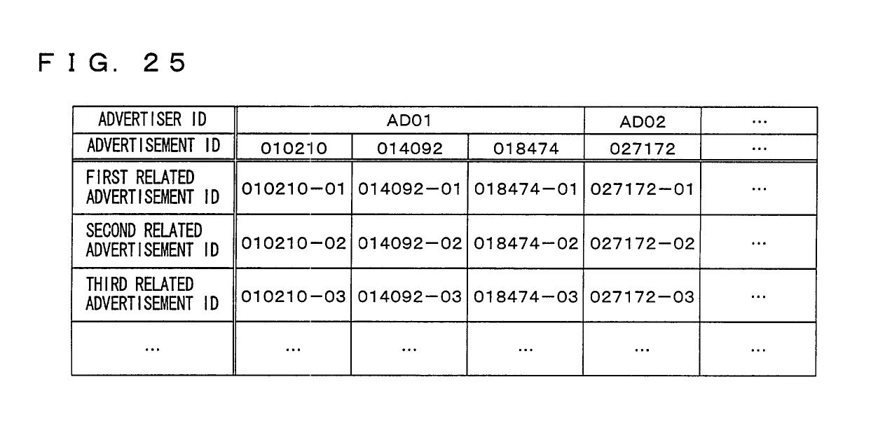

Modem 3000 reads out advertisement schedule data (FIG. 25) from memory 3020 (S3102), and detects the current date (S3104). When the current date corresponds to advertisement data which is the display due date (YES at S3106), advertisement data is read out from cache memory 3030 (S3108), and advertisement data is displayed on liquid crystal monitor 3042(S3110). When the buzzer flag in schedule data is set (YES at S3112), the sound from buzzer 3044 is output (S3114).

When the affirmation request flag is set (YES at S3116), affirmation request lamp 3046 is turned on (S3118). When a view affirmation input is entered through button 3048 (YES at S3122) before the elapse of the affirmation request time (NO at S3122), the affirmation request lamp 3046 is turned off (S3124). View affirmation data is generated (S3126), and transmitted to CMTS 1000 (S3128).

Fee Calculation Operation at Advertisement Server Computer

When advertisement server computer 2000 receives view affirmation data from modem 3000 via CMTS 1000 (YES at S2100), the data for the advertisement affirmed of viewing in the discount rate database (FIG. 12) is updated (S2102). Advertisement server computer 2000 detects the current date (S2104). When the current date is the rate calculation appointed date (for example, at the end of the month) (YES at S2106), the discount rate is calculated for each modem ID (S2108) based on the discount rate database (FIG. 12). The discount rate calculated for each modem ID is transmitted to CMTS 1000 (S2110). Advertisement server computer 2000 calculates the advertisement fee for each advertiser ID (S2112) based on the advertisement fee database (FIG. 13). Advertisement server computer 2000 notifies the advertiser of the advertisement fee for each advertiser ID calculated (S2114). The advertiser that is notified of the advertisement fee pays the CATV service provider the notified advertisement fee through an online accounting server connected to the network.

Fee Calculation Operation at CMTS

When CMTS 1000 receives the discount rate for each modem ID from advertisement server computer 2000 (YES at S1100), determination is made whether the advertisement fee has been collected from the advertiser (S1102). Upon collecting the advertisement fee from the advertiser (YES at S1102), the communication fee and modem usage fee are calculated for each modem ID (S1104). At this stage, the discount rate total amount stored in the discount rate database (FIG. 12) is subtracted from the predetermined communication fee and modem usage fee for each CATV service provider, and the communication fee and modem usage fee for each modem ID are calculated. CMTS 1000 notifies the user of the communication fee and modem usage fee for each modem ID.

Thus, the communication system of the present embodiment can display an advertisement at a modem without depending upon the application in a personal computer. As the value of the advertisement display, the advertisement fee can be collected from an advertiser. The advertisement fee can be appropriated for the discount in the communication fee and modem usage fee to alleviate the amount to be borne by the user. Thus, a communication system can be provided in which the maintenance fee of infrastructure that is not upgraded in the communication system does not have to be covered by the user.

[First Modification of First Embodiment]

A modification of the data process of CMTS 1000 in the first embodiment will be described hereinafter. In this modification corresponding to the data process flow chart of CMTS 1000 shown in FIGS. 14A and 14B, CMTS 1000 transmits communication traffic data to advertisement server computer 2000, instead of transmitting a transmission enable flag to advertisement server computer 2000. Specifically, when CMTS 1000 determines that the received management data is communication traffic data (YES at S1020), communication traffic data is transmitted to advertisement server computer 2000 irrespective of whether the downstream communication traffic is light or not.

Advertisement server computer 2000 receives communication traffic data from CMTS 1000 without receiving a transmission enable flag. When the downstream communication traffic is lighter than a predetermined traffic based on the received communication traffic data, advertisement server computer 2000 reads out advertisement data or advertisement control data from hard disk 2106 and transmits the read out advertisement data or advertisement control data to CMTS 1000.

Similarly in this modification, advertisement data can be transmitted from CMTS 1000 to modem 3000 when the downstream communication traffic is light.

[Second Modification of First Embodiment]

In the second modification of the first embodiment, advertisement server computer 2000 calculates the advertisement fee based on the schedule data displayed at modem 3000.

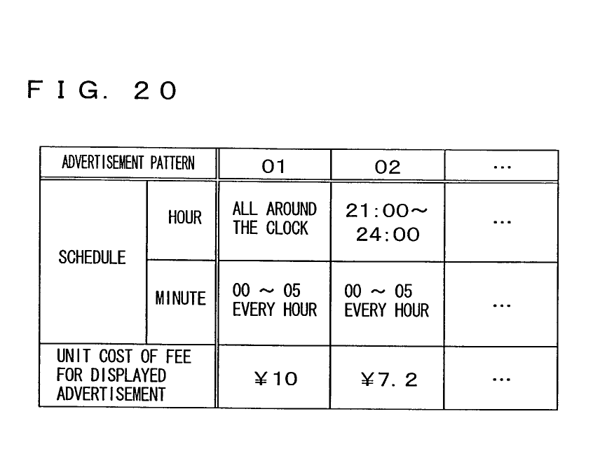

The advertisement fee table stored in hard disk 2106 of advertisement server computer 2000 will be described with reference to FIG. 20. The advertisement fee table stores the schedule to display an advertisement and the unit cost of the fee of the advertisement to be displayed. For example, as to the advertisement pattern of “01”, advertisement data is displayed at modem 3000 at every hour on the hour for five minutes all the day. In this case, the unit cost of the fee of the displayed advertisement is set to 10 yen. A plurality of such advertisement patterns are stored. The unit cost is set high for an advertisement pattern that has the higher possibility of a user viewing the advertisement data displayed at modem 3000, and set lower for an advertisement pattern with lower viewing possibility. Based on this advertisement fee table, the advertisement fee for display in the advertisement fee database (FIG. 13) is calculated.

According to this modification, the advertisement fee to be collected from the advertiser can be calculated based on the advertisement fee corresponding to the schedule to display a predetermined advertisement.

[Other Modifications of First Embodiment]

The advertisement control data of FIGS. 6-8 can be transmitted from CMTS 1000 to modem 3000 instead of being transmitted from advertisement server computer 2000 to modem 3000 via CMTS 1000.

The process at S1020 of FIGS. 14A and 14B has been described wherein CMTS 1000 receives communication traffic data as one type of management data. Specifically, communication traffic data does not have to be received by CMTS 1000, and can be detected by CMTS 1000 per se.

Also, the advertisement fee total amount in the advertisement fee database of FIG. 13 is not limited to 125% the total sum of the advertisement fee for display and the advertisement fee for viewing. The rate can be modified appropriately depending upon the variation of the management fee of the CATV service provider.

The connection of CMTS 1000 and modem 3000 is not limited to the usage of CATV line 1400 alone. CMTS 1000 and modem 3000 can be connected using another line (for example, the general telephone line or the like) together with CATV line 1400. The downstream data transmitted from Internet 4000 to modem 3000 and the advertisement data transmitted from advertisement server computer 2000 to modem 3000 via CMTS 1000 are transmitted through different communication lines. For example, the downstream from Internet 4000 is transmitted through CATV line 1400 whereas the downstream from advertisement server computer 2000 is transmitted though a general telephone line. Accordingly, data can be discriminated and processed based on each communication line instead of discriminating the type of data and modifying the process depending upon the destination included in the header of the received data.

Second Embodiment

In a communication system according to a second embodiment of the present invention, the user can search for advertisement data at modem 3000 based on the above-described first embodiment. The remaining hardware and flow charts are similar to those described above in the first embodiment. Therefore, detailed description thereof will not be repeated here.

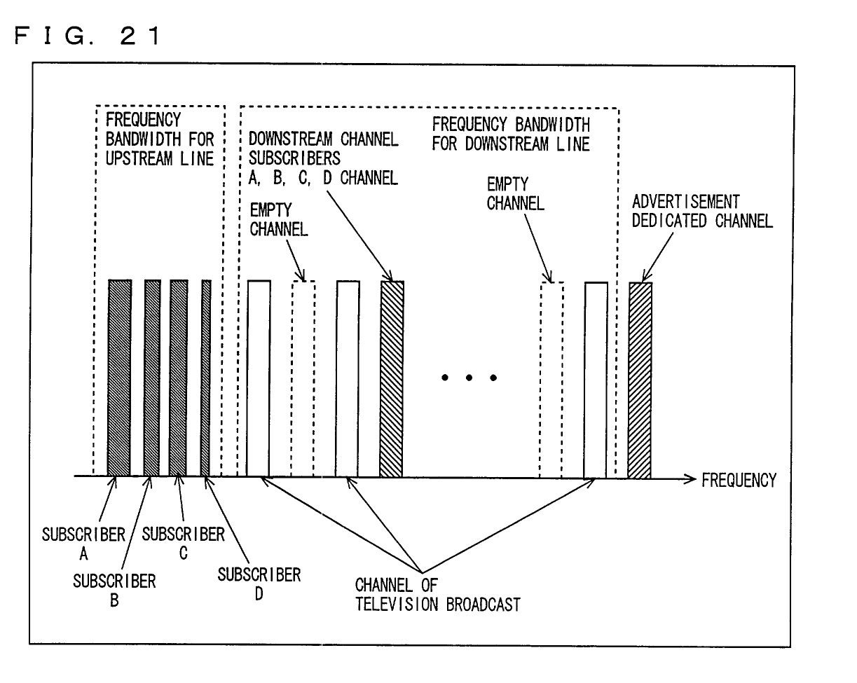

The communication channel between CMTS 1000 and modem 3000 according to the second embodiment will be described with reference to FIG. 21. In the present embodiment, a channel dedicated for advertisement is provided. As shown in FIG. 21, the communication channel between CMTS 1000 and modem 3000 is formed of an upstream line channel set for each user, and a downstream channel using an empty channel for TV broadcasting. In addition, a channel dedicated for advertisement is provided at the high frequency bandwidth side of the downstream channel frequency bandwidth. The advertisement-dedicated channel transmits advertisement data alone from advertisement server computer 2000 to modem 3000 via CMTS 1000 through CATV line 1400. Through this advertisement-dedicated channel, advertisement data is transmitted to modem 3000 irrespective of the communication traffic of the downstream line.

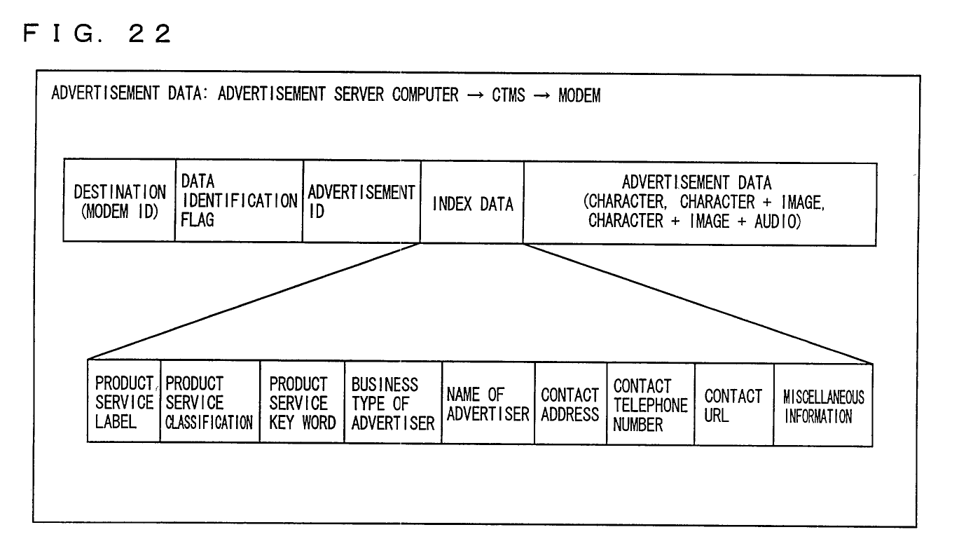

Advertisement data transmitted from advertisement server computer 2000 to modem 3000 via CMTS 1000 will be described with reference to FIG. 22. The advertisement data of FIG. 22 has index data added to the advertisement data of the first embodiment shown in FIG. 5. Referring to FIG. 22, the advertisement data includes a destination (modem ID), a data identification flag, an advertisement ID, index data, and data. Index data includes the product service name, product service classification, product service keyword, the category of business of the advertiser, the name of the advertiser, contact address, contact telephone number, contact URL (Uniform Resource Locators), and other information. Advertisement data can be retrieved based on the index data.

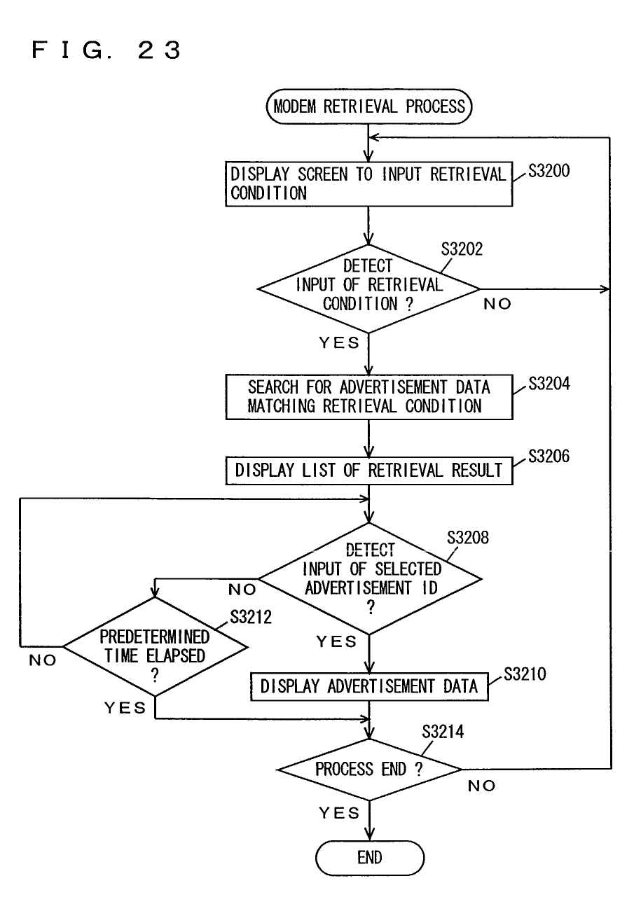

Referring to FIG. 23, the program executed at modem 3000 relates to a retrieval stress. The retrieval process program has a control structure set forth below.

At S3200, CPU 3010 displays a screen to enter the retrieval condition on liquid crystal monitor 3042. At S3202, CPU 3010 determines whether input of a retrieval condition has been detected or not. This determination is based on information input through button 3048. Upon detection of input of a retrieval condition (YES at S3202), control proceeds to S3204, otherwise (NO at S3202), control returns to S3200.

At S3204, CPU 3010 retrieves advertisement data that matches the retrieval condition. At this stage, each data in the index data included in the advertisement data shown in FIG. 22 is used. At S3206, CPU 3010 provides a display of a list of the retrieval result on liquid crystal monitor 3042. At this stage, at least one advertisement ID is displayed.

At S3208, CPU 3010 determines whether detection of input of one advertisement ID among the displayed advertisement ID has been detected or not. Upon detecting input of an advertisement ID (YES at S3208), control proceeds to S3210, otherwise (NO at S3208), control proceeds to S3212.

At S3210, CPU 3010 displays on liquid crystal monitor 3042 the advertisement data identified by the advertisement ID selected by the user.

At S3212, CPU 3010 determines whether a predetermined time has elapsed since the retrieval result list has been displayed. When the predetermined time has elapsed (YES at S3212), control proceeds to S3214, otherwise (NO at S3212), control returns to S3208.

At S3214, CPU 3010 determines whether to end the retrieval process at modem 3000. When the process is to be ended (YES at S3214), this retrieval process ends, otherwise (NO at S3214), control returns to S3200.

An advertisement data retrieval operation based on the above structure and flow chart will be described here.

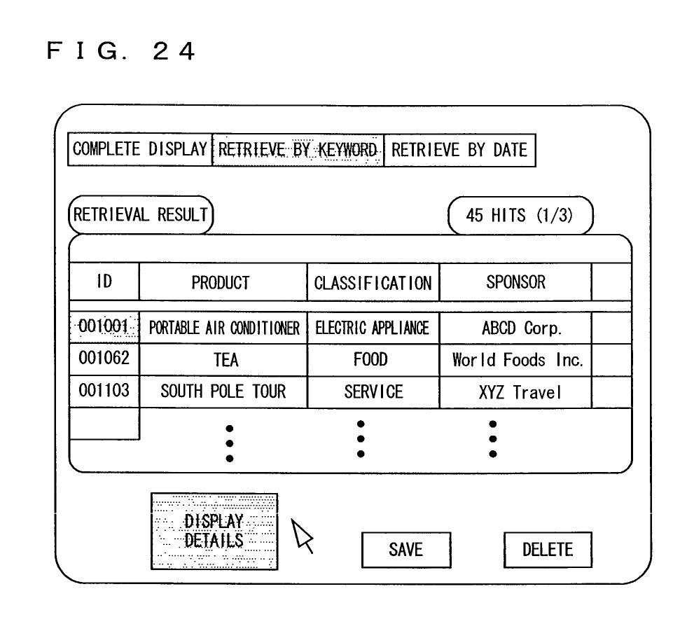

A screen for retrieval condition entry is displayed on liquid crystal monitor 3042 of modem 3000 (S3200). Upon an input of a retrieval condition by the user (YES at S3202), modem 3000 searches for advertisement data that matches the retrieval condition (S3204). A list of the retrieval result is displayed on liquid crystal monitor 3042 (S3206). A display example on liquid crystal monitor 3042 at this current stage is shown in FIG. 24. By selecting and requesting detailed display of a certain advertisement ID under the state shown in FIG. 24, input of the selected advertisement ID is detected (YES at S3208). Advertisement data corresponding to the selected advertisement ID is displayed (S3210).

According to the communication system of the present embodiment, advertisement data of interest to the user can be retrieved and displayed from the advertisement data stored in the modem for display.

In the present embodiment, retrieval can be carried out by personal computer 3100 instead of modem 3000. Also, the index data shown in FIG. 22 is not limited to that received at modem 3000 from advertisement server computer 2000 via CMTS 1000. The advertisement data shown in FIG. 5 may be received by modem 3000 from advertisement server computer 2000, whereby modem 3000 generates index data based on the received advertisement data (FIG. 5). In this case, modem 3000 automatically generates index data based on characters and the like of the advertisement data included in advertisement data (FIG. 5).

Third Embodiment

A communication system according to a third embodiment of the present invention can have the user request data related to advertisement data at modem 3000 of the first embodiment. The remaining hardware structure and flow charts are similar to those of the first embodiment. Therefore, detailed description thereof will not be repeated here.

The related information database stored in hard disk 2106 of advertisement server computer 2000 will be described with reference to FIG. 25. The related information database stores a first related advertisement ID, a second related advertisement ID and third related advertisement ID related to advertisement information identified by respective advertisement IDs on an advertisement ID basis for respective advertiser IDs. For example, the first related advertisement ID is stored as “010210-01” and the second related advertisement ID is stored as “010210-02” for the advertisement identified by the advertisement ID of “010210” for an advertiser who is identified by an advertiser ID of “AD01”.

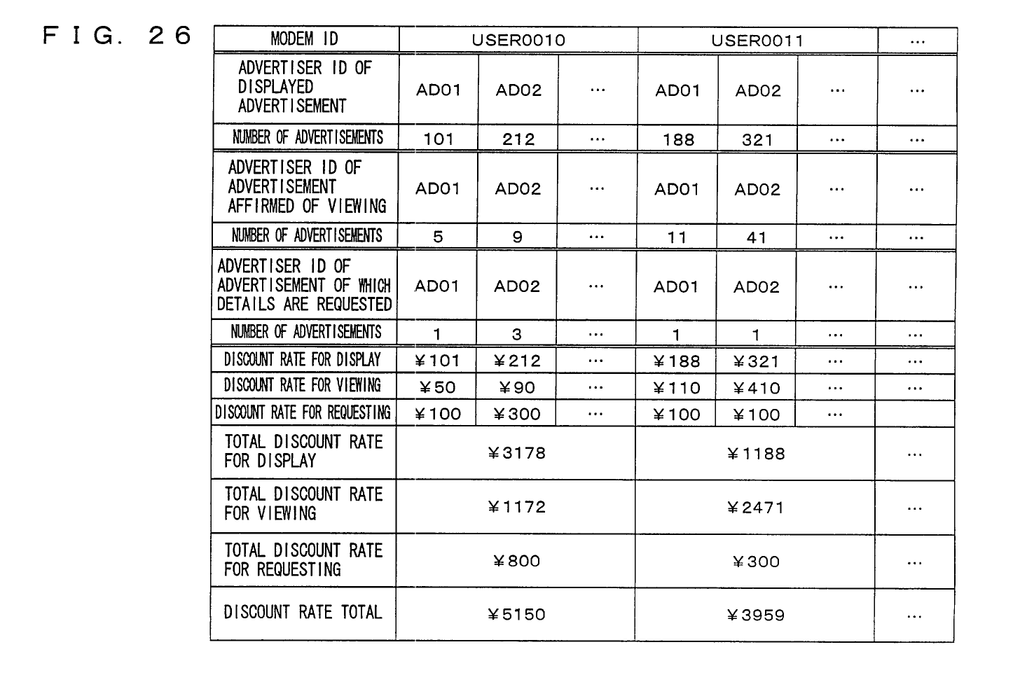

The discount rate database stored in hard disk 2106 of advertisement server computer 2000 will be described with reference to FIG. 26. The discount rate database (FIG. 26) of the present embodiment further includes an advertiser ID of the advertiser who's details are requested, and the number of advertisements by that advertiser ID in addition to the discount rate database of the first embodiment (FIG. 12). Also, the discount rate for a request, and the total amount of the discount rate for requests are included. The total amount of the discount rate is the sum of the total of the discount rate for display, the total of the discount rate for being viewed, and the total of the discount rate for being requested. The discount rate for a request is set as 100 yen per one advertisement count. If the user requests related advertisement of the advertisement data displayed at modem 3000, the discount rate will further be added. The added amount is set higher than an advertisement simply displayed, and further set higher than an advertisement affirmed of being viewed.

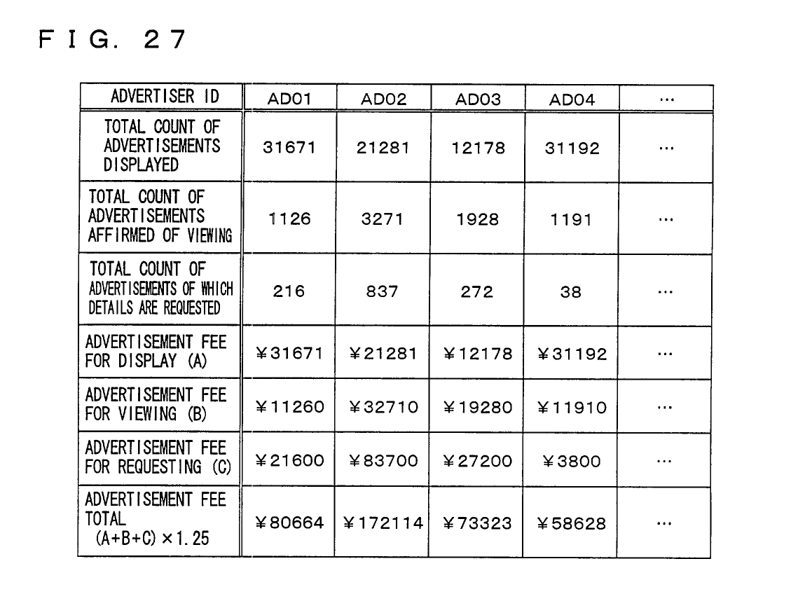

The advertisement fee database stored in hard disk 2106 of advertisement server computer 2000 will be described with reference to FIG. 27. The advertisement fee database of the present embodiment (FIG. 27) includes a total count of the number of advertisements of which details are requested, and the advertisement fee for a request for each advertiser ID, in addition to the advertisement fee database of the first embodiment (FIG. 13). The total amount of the advertisement fee is set 125% the sum of the advertisement fee for display, the advertisement fee for being viewed, and the advertisement fee for being requested. The advertisement usage amount for a request is assumed to be 100 yen per one advertisement count.

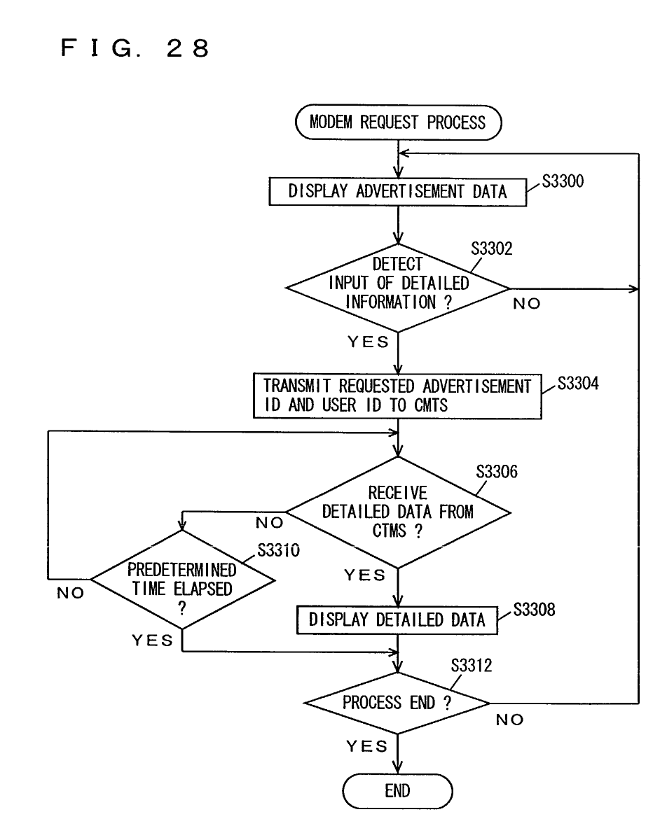

Referring to FIG. 28, the program executed by modem 3000 in the present embodiment relates to a request process. The request process program has a control structure set forth below.

At S3300, CPU 3010 displays advertisement data on liquid crystal monitor 3042. At S3302, CPU 3010 determines whether input of detailed information has been detected or not. This determination is based on the information input by the user through button 3048. Upon detection of an input of detailed information (YES at S3302), control proceeds to 3304, otherwise (NO at S3302), control proceeds to S3300.

At S3304, CPU 3010 transmits details request data including the advertisement ID requested and the user ID to CMTS 1000. At S3306, CPU 3010 determines whether detailed data has been received from CMTS 1000. If detailed data is received from CMTS 1000 (YES at S3306), control proceeds to S3308, otherwise (NO at S3306), control proceeds to S3310. At S3308, CPU 3010 displays the received detailed data on liquid crystal monitor 3042.

At S3310, CPU 3010 determines whether a predetermined time has elapsed since the transmission of the requested advertisement ID and user ID to CMTS 1000. When the predetermined time has elapsed (YES at S3310) control proceeds to S3312, otherwise (NO at S3310), control proceeds to S3306.

At S3312, CPU 310 determines whether to end the request process or not. When the process is to be ended (YES at S3312), the request process of modem 3000 ends, otherwise (NO at S3312), control proceeds to S3300.

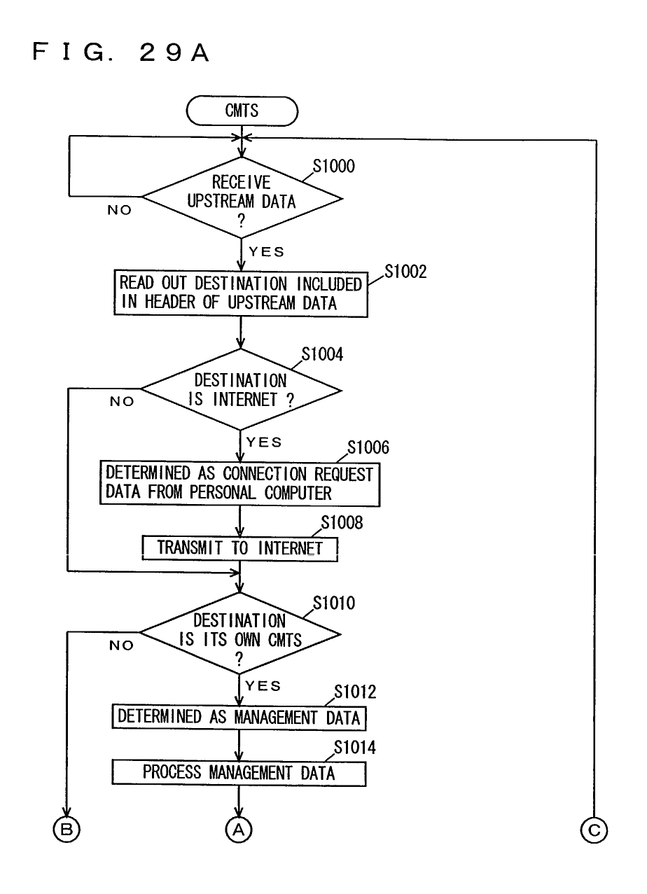

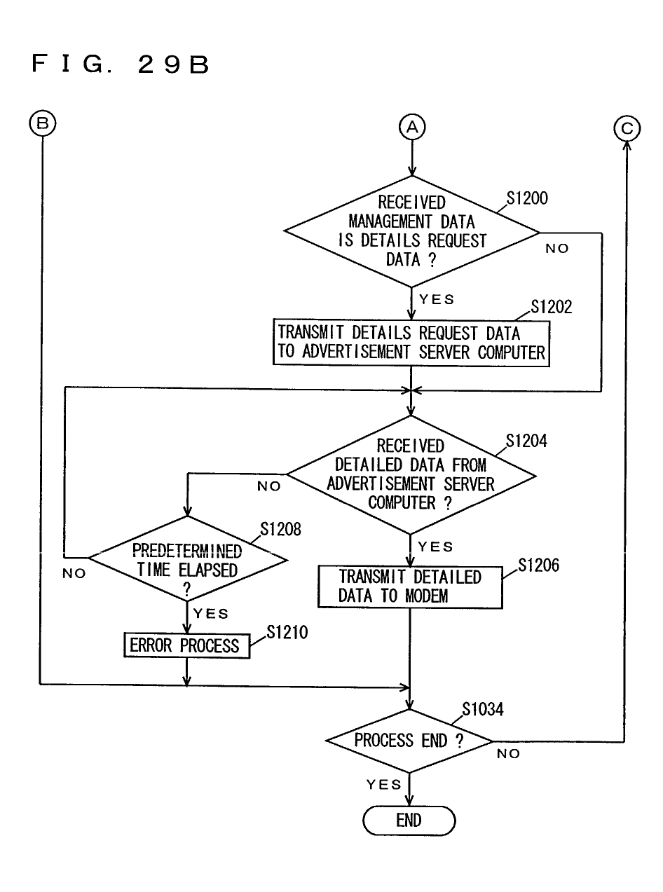

Referring to FIGS. 29A and 29B, the program executed by CMTS 1000 according to the present embodiment relates to a data process. The data process program has a control structure set forth below. The steps in the process of FIGS. 29A and 29B identical to those of the process in FIGS. 14A and 14B have the same step number allotted, and the process thereof are identical. Therefore, detailed description thereof will not be repeated here.

At S1200, CPU 1010 determines whether the received management data is details request data or not. When the received management data is details request data (YES at S1200), control proceeds to S1202, otherwise (NO at S1200), control proceeds to S1204.

At S1202, CPU 1010 transmits the details request data to advertisement server computer 2000. At S1204, CPU 1010 determines whether detailed data has been received from advertisement server computer 2000. When detailed data is received from advertisement server computer 2000 (YES at S1204), control proceeds to S1206, otherwise (NO at S1204), control proceeds to S1208. At S1206, CPU 1010 transmits the detailed data to modem 3000.

At S1208, CPU 1010 determines whether a predetermined time has elapsed since details request data has been transmitted to advertisement server computer 2000. When the predetermined time has elapsed (YES at S1208), control proceeds to S1210, otherwise (NO at S1208), control returns to S1204. At S1210, CPU 1010 carries out an error process. In this error process of S1210, occurrence of a trouble in communication with advertisement server computer 2000 is notified at, for example, the monitor of management terminal 1100 connected to CMTS 1000.

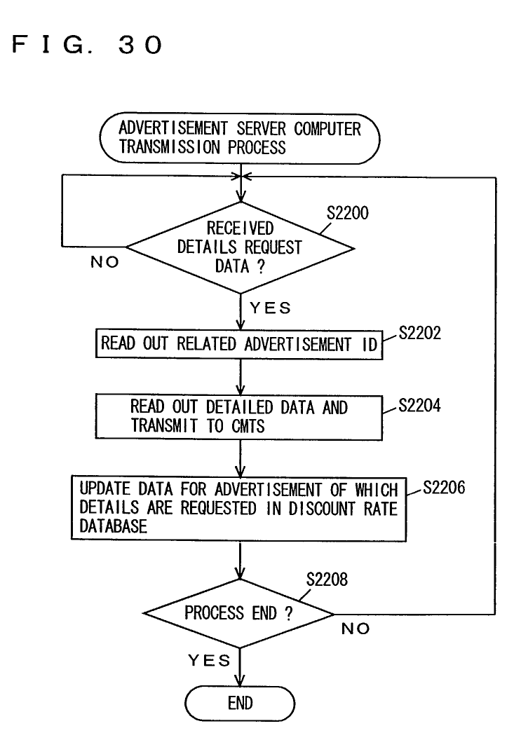

Referring to FIG. 30, the program executed by advertisement server computer 2000 in the present embodiment relates to a transmission process. The transmission process program has a control structure set forth below.

At S2200, CPU 2102 determines whether details request data has been received from CMTS 1000 or not. When details request data has been received (YES at S2200), control proceeds to S2202, otherwise (NO at S2200), control returns to S2200 to wait for reception of details request data from CMTS 1000.

At S2202, CPU 2102 reads out the related advertisement ID from the related information database (FIG. 25) stored in hard disk 2106. At S2204, CPU 2102 reads out and transmits to CMTS 1000 the detailed data from hard disk 2102 based on the related advertisement ID. At this stage, the destination is set based on the modem ID included in the details request data. At S2206, CPU 2102 updates the data for the advertisement of which details are requested in the discount rate database (FIG. 26) stored in hard disk 2106.

The data request operation based on the above structure and flow chart will be described here.

When advertisement data is displayed on liquid crystal monitor 3042 of modem 3000 (S3300), and the user inputs detailed information (YES at S3302), modem 3000 transmits the details request data including the requested advertisement ID and user ID to CMTS 1000 (S3304).

When CMTS 1000 receives upstream data (YES at S1000), and determines that the received management data is details request data (YES at S1200), the details request data is transmitted to advertisement server computer 2000 (S1202).

Upon receiving details request data from CMTS 1000 (YES at S2200), advertisement server computer 2000 reads out the related advertisement ID from the related information database (FIG. 25) stored in hard disk 2106 (S2202). Based on the related advertisement ID, detailed data is read out from hard disk 2106 and transmitted to CMTS 1000 (S2204). The data for the advertisement of which details are requested in the discount rate database (FIG. 26) is updated (S2206).

When CMTS 1000 receives the detailed data from advertisement server computer 2000 (YES at S1204), the detailed data is transmitted to modem 3000 (S1206).

If modem 3000 receives detailed data from CMTS 1000 (YES at S3306) before the elapse of a predetermined time since the transmission of the advertisement ID and user ID to CMTS 1000 (NO at S3310), the received detailed data is displayed on liquid crystal monitor 3042 (S3308).

Advertisement server computer 2000 calculates the advertisement fee total amount for each advertiser ID and stores the calculated amount into the advertisement fee database (FIG. 27) based on the discount rate database (FIG. 26) stored in hard disk 2106. Each advertiser is notified of the calculated advertisement fee. The operation of the notified advertiser paying the advertisement fee to the CATV service provider is carried out.

According to the communication system of the present embodiment, the user is prompt to view information related to the advertisement data displayed on the modem (for example, detailed advertisement information). Corresponding to the case where the user requests detailed information, a higher advertisement fee can be collected from the advertiser.

[Modification Common to First to Third Embodiments]

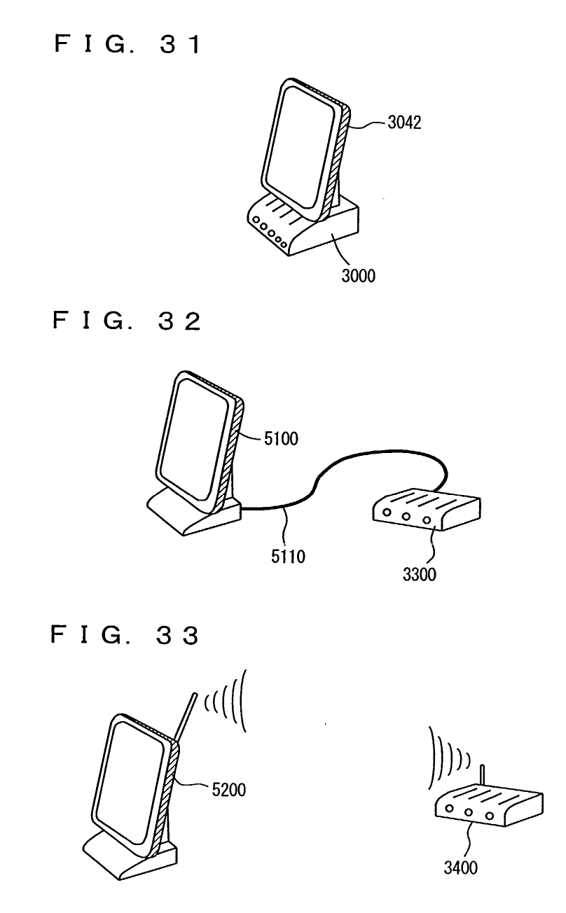

A modification of liquid crystal monitor 3042 of modem 3000 will be described hereinafter with reference to FIGS. 31-33. The above-described embodiments are based on a structure in which liquid crystal monitor 3042 is included in modem 3000 as shown in FIG. 4.

The present invention is not limited to such a structure. As shown in FIG. 31, liquid crystal monitor 3042 included in modem 3000 may be a large liquid crystal display. Alternatively, the structure shown in FIG. 23 may be implemented in which modem 3300 does not include liquid crystal monitor 3042, and a liquid crystal monitor 5100 is connected through a connection cord 5110. Furthermore, as shown in FIG. 33, a modem 3400 may incorporate a short-range radio communication device (for example, Bluetooth device) absent of a liquid crystal monitor, and be connected to a liquid crystal monitor 5200 incorporated in a corresponding short-range radio communication device through radio.

In any of the modifications of FIGS. 31-33, advertisement data can be displayed on the liquid crystal monitor and viewed by a user.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data communication apparatus to connect first and second computers, comprising:
a reception circuit receiving data from said first computer,
a conversion circuit connected to said reception circuit to convert said received data into data for transmission to said second computer,
a transmission circuit connected to said conversion circuit to transmit said converted data to said second computer,
an output circuit to output information so as to be visually perceived by a user of said data communication apparatus, and
a control circuit connected to said reception circuit and said output circuit to control said output circuit such that advertisement information included in data received from said first computer is output to said output circuit.

2. The data communication apparatus according to claim 1, wherein
said output circuit comprises a circuit to display data, and
said control circuit comprises a circuit controlling said output circuit such that data is displayed at said output circuit based on said advertisement information.

3. The data communication apparatus according to claim 1, wherein
said output circuit comprises a circuit emitting a sound, and
said control circuit comprises a circuit controlling said output circuit such that a sound is output to said output circuit based on said advertisement information.

4. The data communication apparatus according to claim 1, wherein said output circuit comprises a circuit to display data,
said data communication apparatus further comprising a circuit to provide an output such that the user of said communication apparatus is prompted to view advertisement information when said advertisement information is displayed at said output circuit.

5. The data communication apparatus according to claim 1, wherein said control circuit comprises a circuit extracting said advertisement information from data received from said first computer, and a circuit controlling said output circuit such that the extracted advertisement information is output to said output circuit.

6. The data communication apparatus according to claim 1, wherein said control circuit comprises a circuit extracting said advertisement information from data received from said first computer based on a frequency bandwidth in which said data is transmitted, and a circuit controlling said output circuit such that the extracted advertisement information is output to said output circuit.

7. The data communication apparatus according to claim 1, wherein said control circuit comprises a circuit extracting said advertisement information from data received from said first computer based on a type of communication line between said first computer and said communication apparatus, and a circuit controlling said output circuit such that the extracted advertisement information is output to said output circuit.

8. The data communication apparatus according to claim 1, wherein said first computer and said data communication apparatus are connected by at least one line of a cable television line, a general telephone line, and a digital telephone line.

9. The data communication apparatus according to claim 1, wherein said first computer and said data communication apparatus communicate said data using any of a voice conversation bandwidth and a frequency bandwidth higher than said voice conversation bandwidth for a general telephone line.

10. The data communication apparatus according to claim 1, further comprising:
a storage circuit connected to said reception circuit to store said advertisement information, and
a schedule data reception circuit receiving schedule data representing an output schedule of said advertisement information from said first computer,
wherein said control circuit comprises a circuit controlling said output circuit such that said advertisement information is output to said output circuit based on said received schedule data.

11. The data communication apparatus according to claim 1, further comprising:
a storage circuit connected to said reception circuit to store said advertisement information, and
a schedule data generation circuit generating schedule data representing an output schedule of said advertisement information,
wherein said control circuit comprises a circuit controlling said output circuit such that said advertisement information is output to said output circuit based on said generated schedule data.

12. The data communication apparatus according to claim 1, further comprising:
an input circuit for the user of said data communication apparatus to input affirmation information affirming output of advertisement information by said output circuit, and
an affirmation information transmission circuit connected to said input circuit to transmit said input affirmation information to said first computer.

13. The data communication apparatus according to claim 1, further comprising:
an input circuit for the user of said data communication apparatus to input request information requesting information related to said advertisement information based on advertisement information output by said output circuit,
a request transmission circuit connected to said input circuit to transmit said input request information to said first computer, and
a request information control circuit controlling said output circuit such that related information transmitted from said first computer is output in response to said request information.

14. The data communication apparatus according to claim 1, further comprising a storage circuit storing said advertisement information, said advertisement information including first advertisement data representing contents of an advertisement, and second advertisement data for retrieving said first advertisement data,
wherein said output circuit comprises a circuit displaying said second advertisement data,
said data communication apparatus further comprising:
an input circuit for the user of said data communication apparatus to input said second advertisement data, and
a retrieval circuit connected to said storage circuit and said input circuit to retrieve first advertisement data based on second advertisement information input by said user,
wherein said output circuit comprises a circuit displaying said first advertisement data retrieved by said retrieval circuit.

15. The data communication apparatus according to claim 1, further comprising:
a storage circuit storing said advertisement information, and
a generation circuit generating advertisement retrieval data to retrieve said advertisement information based on said advertisement information,
wherein said output circuit comprises a circuit displaying said advertisement retrieval data,
said data communication apparatus further comprising an input circuit for the user of said data communication apparatus to input said advertisement retrieval data, and
a retrieval circuit connected to said storage circuit and said input circuit to retrieve advertisement information based on advertisement retrieval data input by said user,
wherein said output circuit further comprises a circuit displaying said advertisement information retrieved by said retrieval circuit.

16. A data communication apparatus to connect first and second computers, comprising:
reception means for receiving data from said first computer,
conversion means connected to said reception means for converting said received data into data for transmission to said second computer,
transmission means connected to said conversion means for transmitting said converted data to said second computer,
output means for outputting information so as to be visually perceived by a user of said data communication apparatus, and
control means connected to said reception means and said output means for controlling said output means such that advertisement information included in data received from said first computer is output to said output means.

17. The data communication apparatus according to claim 16, wherein
said output means comprises means for displaying data, and
said control means comprises means for controlling said output means such that the data is displayed at said output means based on said advertisement information.

18. The data communication apparatus according to claim 16, wherein
said output means comprises means for emitting a sound, and
said control means comprises means for controlling said output means such that a sound is output to said output means based on said advertisement information.

19. The data communication apparatus according to claim 16, wherein said output means comprises means for displaying data,
said data communication means further comprising means for providing an output such that the user of said communication apparatus is prompted to view advertisement information when said advertisement information is displayed at said output means.

20. The data communication apparatus according to claim 16, wherein said control means comprises means for extracting said advertisement information from data received from said first computer, and means for controlling said output means such that said extracted advertisement information is output to said output means.

21. The data communication apparatus according to claim 16, wherein said control means comprises means for extracting said advertisement information from data received from said first computer based on a frequency bandwidth in which said data is transmitted, and means for controlling said output means such that said extracted advertisement information is output to said output means.

22. The data communication apparatus according to claim 16, wherein said control means comprises means for extracting said advertisement information from data received from said first computer based on a type of communication line between said first computer and said data communication apparatus, and means for controlling said output means such that said extracted advertisement information is output to said output means.

23. The data communication apparatus according to claim 16, wherein said first computer and said data communication apparatus are connected by at least one line among a cable television line, a general telephone line, and a digital telephone line.

24. The data communication apparatus according to claim 16, wherein said first computer and said data communication apparatus communicate said data using any of a voice conversation bandwidth and a frequency bandwidth higher than said voice conversation bandwidth for a general telephone line.

25. The data communication apparatus according to claim 16, further comprising:
storage means connected to said reception means for storing said advertisement information, and
schedule data reception means for receiving schedule data representing an output schedule of said advertisement information from said first computer,
wherein said control means comprises means for controlling said output means such that said advertisement information is output to said output means based on said received schedule data.

26. The data communication apparatus according to claim 16, further comprising:
storage means connected to said reception means for storing said advertisement information, and
schedule data generation means for generating schedule data representing an output schedule of said advertisement information,
wherein said control means comprises means for controlling said output means such that said advertisement information is output to said output means based on said generated schedule data.

27. The data communication apparatus according to claim 16, further comprising:
input means for the user of said data communication apparatus to input affirmation information affirming output of advertisement information by said output means, and
affirmation information transmission means connected to said input means for transmitting said input affirmation information to said first computer.

28. The data communication apparatus according to claim 16, further comprising:
input means for the user of said data communication apparatus to input request information requesting information related to said advertisement information based on advertisement information output by said output means,
request transmission means connected to said input means for transmitting said input request information to said first computer, and
request information control means for controlling said output means such that related information transmitted from said first computer is output in response to said request information.

29. The data communication apparatus according to claim 16, further comprising storage means for storing said advertisement data, said advertisement data including first advertisement data representing contents of an advertisement, and second advertisement data to retrieve said first advertisement data,
wherein said output means comprises means for displaying said second advertisement data,
said data communication apparatus further comprising:
input means for the user of said data communication apparatus to input said second advertisement data, and
retrieval means connected to said storage means and said input means for retrieving first advertisement data based on the second advertisement information input by said user,
wherein said output means comprises means for displaying said first advertisement data retrieved by said retrieval means.

30. The data communication apparatus according to claim 16, further comprising:
storage means for storing said advertisement information, and
generation means for generating advertisement retrieval data to retrieve said advertisement information based on said advertisement information,
wherein said output means comprises means for displaying said advertisement retrieval data,
said data communication apparatus further comprising:
input means for the user of said data communication apparatus to input said advertisement retrieval data, and
retrieval means connected to said storage means and said input means for retrieving advertisement information based on advertisement retrieval data input by said user,
wherein said control means further comprises means for displaying said advertisement information retrieved by said retrieval means.

31. A data communication computer connected to a first computer, said data communication computer comprising a first instruction circuit to instruct said first computer to transmit data including advertisement information to a data communication apparatus to connect first and second computers,
said data communication apparatus converting and transmitting to said second computer data received from said first computer, and outputting advertisement information included in the data received from said first computer,
said data communication computer further comprising a calculation circuit calculating an accounting amount to be collected from an advertiser of said advertisement information.

32. The data communication computer according to claim 31, said first computer detecting a communication traffic between said first computer and said second computer, and transmitting request information requesting said advertisement information to said data communication computer based on said communication traffic,
said data communication computer further comprising a reception circuit receiving said request information from said first computer,
wherein said first instruction circuit comprises a circuit instructing said first computer to transmit data including advertisement information to said data communication apparatus based on said request information.

33. The data communication computer according to claim 31, wherein said first computer detects a communication traffic between said first computer and said second computer, and transmits said communication traffic to said data communication computer,
said data communication computer further comprising a reception circuit receiving said communication traffic from said first computer,
wherein said first instruction circuit comprises a circuit instructing said first computer to transmit data including advertisement information to said data communication apparatus based on said communication traffic.

34. The data communication computer according to claim 18, further comprising a second instruction circuit instructing said first computer to transmit schedule data representing an output schedule of said advertisement information to said data communication apparatus,
wherein said calculation circuit comprises a circuit calculating said accounting amount based on said schedule data.

35. The data communication computer according to claim 31, said data communication apparatus transmitting affirmation information of a user of said data communication apparatus viewing advertisement information to said second computer,
said data communication computer further comprising a detection circuit detecting said affirmation information,
wherein said calculation circuit comprises a circuit calculating said accounting amount based on said affirmation information.

36. The data communication computer according to claim 31, said data communication apparatus transmitting request information requesting related information related to said advertisement information to said first computer, and said first computer transmitting said request information to said data communication computer,
said data communication computer further comprising:
a detection circuit detecting said request information, and
a second instruction circuit connected to said deduction circuit and said first computer to instruct said first computer to transmit said related information to said data communication apparatus.

37. The data communication computer according to claim 21, wherein said calculation circuit further comprises a circuit calculating said accounting amount based on said request information.

38. The data communication computer according to claim 31, further comprising a fee calculation circuit calculating, based on said accounting amount, a fee to use a line between said first computer and said second computer, wherein said fee is to be paid by a user of said second computer.

39. The data communication computer according to claim 31, further comprising a fee calculation circuit calculating, based on said accounting amount, a fee to use a data communication apparatus connecting said first and second computers, wherein said fee is to be paid by a user of said second computer.

40. A data communication computer connected to a first computer, said data communication computer comprising:
first instruction means for instructing said first computer to transmit data including advertisement information to a data communication apparatus to connect first and second computers,
said data communication apparatus converting and transmitting to said second computer data received from said first computer, and outputting advertisement information included in the data received from said first computer,
said data communication computer further comprising calculation means for calculating an accounting amount to be collected from an advertiser of said advertisement information.

41. The data communication computer according to claim 40, wherein said first computer detects a communication traffic between said first computer and said second computer, and transmits request information requesting said advertisement information to said data communication computer based on said communication traffic,
said data communication computer further comprising reception means for receiving said request information from said first computer,
wherein said first instruction means comprises means for instructing said first computer to transmit data including advertisement information to said data communication apparatus based on said request information.

42. The data communication computer according to claim 40, wherein said first computer detects a communication traffic between said first computer and said second computer, and transmits said communication traffic to said data communication computer,
said data communication computer further comprising reception means for receiving said communication traffic from said first computer,
wherein said first instruction means comprises means for instructing said first computer to transmit data including advertisement information to said data communication apparatus.

43. The data communication computer according to claim 18, further comprising second instruction means for instructing said first computer to transmit schedule data representing an output schedule of said advertisement information to said data communication apparatus,
wherein said computer means comprises means for calculating said accounting amount based on said schedule data.

44. The data communication computer according to claim 40, wherein said data communication apparatus transmits affirmation information of a user of said data communication apparatus viewing advertisement information to said second computer,
said data communication computer further comprising detection means for detecting said affirmation information,
wherein said calculation means comprises means for calculating said accounting amount based on said affirmation information.

45. The data communication computer according to claim 40, wherein said data communication apparatus transmits request information requesting related information related to said advertisement information to said first computer, and said first computer transmits said request information to said data communication computer,
said data communication computer further comprising:
detection means for detecting said request information, and
second instruction means connected to said detection means and said first computer for instructing said first computer to transmit said related information to said data communication apparatus.

46. The data communication computer according to claim 21, wherein said calculation means comprises means for calculating said accounting amount based on said request information.

47. The data communication computer according to claim 40, further comprising fee calculation means for calculating, based on said accounting amount, a fee to use a line between said first computer and said second computer, wherein said fee is to be paid by a user of said second computer.

48. The data communication computer according to claim 40, further comprising fee calculation means for calculating, based on said accounting amount, a fee to use a data communication apparatus to connect said first computer and said second computer, wherein said fee is to be paid by a user of said second computer.
